(19) United States
(12) Patent Application Publication
(10) Pub. No.: US 2022/0372770 A1
(43) Pub. Date: Nov. 24, 2022

(54) MORTAR CORRECTION TOOL FOR EVEN INSTALLATION OF ACCENT TILE

(71) Applicant: Jesus Alberto Beltran Robles, Grove City, OH (US)

(72) Inventor: Jesus Alberto Beltran Robles, Grove City, OH (US)

(21) Appl. No.: 17/748,846

(22) Filed: May 19, 2022

Related U.S. Application Data
(60) Provisional application No. 63/190,338, filed on May 19, 2021.

(51) Int. Cl. E04F 21/16; G01B 3/04

(52) U.S. Cl. CPC E04F 21/161; G01B 3/04

(57) ABSTRACT

An apparatus for applying mortar to a wall or floor surface for accent tiles is disclosed. The apparatus has an elongated first piece comprising a top piece joined with a bottom piece having a plurality of slots that are attachable to a second piece and a third piece. Rulers are positioned on the edges of the pieces. To use, a thickness of accent tile is measured as well as a length or width of accent tile. The user adjusts the positioning of the second piece and the third piece accordingly. Once the components are fastened together, the user applies mortar to a gap between pieces of non-accent tile and scrapes off an amount of mortar that is not needed, leaving behind the correct, smoothed amount of mortar that will allow the measured thickness of the accent tile to fit in between the non-accent tile in an even and level manner.

### CROSS-REFERENCE TO RELATED APPLICATION

This application is a non-provisional application which claims priority to U.S. Provisional Patent Application No. 63/190,338 filed on May 19, 2021, which is incorporated in its entirety.

### FIELD OF THE DISCLOSURE

The present invention relates to a new tool that can be used to remove excess mortar from a wall or floor surface where accent tiles are to be installed between surrounding pieces of non-accent tile to ensure that the accent tiles lay flat over the underlying mortar material and do not project past the surrounding pieces of non-accent tile.

### BACKGROUND

Tile installation work can include the installation of decorative or accent tile. Decorative or accent tiles are often installed in order to add an attractive design feature to a floor or wall that draws the eye in to the decorative or accent tile. Accent tiles may be used as an accent border or to cover an entire wall or floor in some cases. Accent tiles are frequently used on a wall behind a kitchen stove or kitchen sink or elsewhere in a kitchen as a backsplash. Additionally, accent tiles are frequently added to showers to provide a distinguishing focal feature on the shower wall or floor. Accent tiles catch the eye and provide a visually attractive and captivating design element of a space because accent tiles differ in their appearance from the surrounding non-accent tile. The accent tile may include a series or rows of uniquely shaped and colored accent tile pieces that look different visually in some manner from the surrounding non-accent tile installed on a floor or wall. Accent tiles may be made from or incorporate a variety of materials including, but not limited to, ceramic, porcelain, colorful glass, stone, travertine, beads, shells, and many other elements that may be incorporated into the accent tile.

When a section of accent tile is installed as a border or an accent design feature, it is often difficult to anticipate how much mortar to lay on the underlying surface (i.e., floor surface or wall surface). Accent tiles are often much thinner than non-accent tiles. The contractor installing the accent tile does not want the accent tile to project out further past, whether in an outward or upward direction, the surrounding non-accent tiles located above or below or to the sides of where the accent tile will be positioned in a kitchen, bathroom, or any other location. In order to apply the accent tile, current methods of application of mortar include the contractor having to guess or estimate how much mortar is needed to achieve a desired thickness of mortar that will also allow for the thickness of the accent tile that will be placed above the applied mortar in order to become equal to the depth of the surrounding non-accent tile located above or below or to the sides of the accent tile.

Currently, contractors have various methods to address adding accent tile to a wall and providing a correct amount of mortar behind or beneath the accent tile. Sometimes, the contractor may use a piece of wood or other material that can be mounted or adhered or otherwise attached to a wall surface or flooring surface to provide some additional material to cover the open area between the non-accent tile pieces located above or below or to the sides of the accent tile. The contractor may then mount the piece of wood or other material to the wall or floor, and then provide some amount of mortar over that piece of wood or other material and position the accent tile over the mortar. The contractor hopes that the accent tile does not project too far outwardly or upwardly past the depth of the installed non-accent tiles on the floor surface or wall surface, and that the mortar that has been applied does not seep too much through the exposed joints of the accent tile, which still need to have caulk or grout applied to them to seal the accent tile correctly. This method is not ideal and it is not always possible to obtain a piece of wood or other material to position beneath the accent tile.

It is preferable to apply the mortar to the wall or floor surface being worked on directly. Most often, contractors currently apply many layers of mortar and smooth the mortar down, and then remove the excess amount of mortar little by little using one or more tools until a desired thickness of mortar is achieved. Trowels, which are small handheld tools with a flat, pointed blade, are an example of a type of tool that is used to apply and spread mortar on a wall or floor surface. Sponges and rags may also be used to even out or wipe off the applied mortar. Further, the edges of levels are often used to remove excess mortar material that exceeds the thickness desired by the contractor.

Lacking from these existing methods is a way to quickly and evenly remove a sufficient amount of excess mortar from a surface of a wall or floor in approximately a single attempt by a contractor that still leaves a proper amount of room for an accent tile to be positioned over the remaining mortar and for that accent tile to not project further past the surrounding non-accent tile, and also for the accent tile to be applied evenly and to lay flat over the remaining mortar.

Accordingly, there is a need for an alternative to the existing methods for installing accent tile and laying mortar beneath the accent tile that overcomes these existing deficiencies and provides a better finished work product.

### SUMMARY

In a non-limiting embodiment, a mortar correction tool is described comprising at least a first piece, a second piece, and a third piece that are connected by one or more dedicated fasteners. The mortar correction tool is meant to be used to scrape off an excess amount of mortar applied to a wall or floor surface between a first piece of non-accent piece of tile and a second piece of non-accent of tile, whereby a piece of accent tile is intended to be positioned over the mortar. The excess amount of mortar is removable in a controlled, measured manner whereby the tool has built in rulers, in a non-limiting embodiment to properly position the components of the mortar correction tool to remove the correct amount of mortar so that when the accent tile is positioned between the first piece of non-accent tile and the second piece of non-accent tile, the mortar is the right thickness and the accent tile is level and even with the first piece of non-accent tile and the second piece of non-accent tile and does not jut past the first piece of non-accent tile and the second piece of non-accent tile.

In a non-limiting embodiment, the first piece comprises a top piece comprising a plurality of slots as well as a bottom piece comprising a first slot positioned near a top surface of the top piece and a second slot positioned near a bottom surface of the top piece. In a non-limiting embodiment, the top piece and the bottom piece are fixedly attached to each other. In a non-limiting embodiment, for the first piece, a lower surface of a back side of the top piece is fixedly attached on top of an upper area on a front side of the bottom piece such that a bottom edge of the top piece forms an overhang over the bottom piece. In other embodiments, the top piece and the bottom piece may be removably attached to each other.

In a non-limiting embodiment, the mortar correction tool comprises a second piece that comprises a first slot that extends partially along a width of the second piece near a top surface of the second piece and a second slot that extends partially along the width of the second piece near a bottom surface of the second piece. The mortar correction tool may further comprise a third piece comprising an angled slope at a bottom surface of the third piece, whereby the third piece further comprises a backwardly oriented L-shaped slit carved out of a middle of the third piece, the backwardly oriented L-shaped slit having a vertical slit that is perpendicular to a horizontal slit carved in the middle of the third piece. A series of slots extend adjacent to the vertical slit and extend into the vertical slit, wherein the series of slots of the third piece are configured to align horizontally with the plurality of slots of the top piece of the first piece. When assembled, the second piece is configured to be positioned over the bottom piece of the first piece under the overhang formed by the top piece, wherein the second piece is configured to be held in place with a first fastener that passes through the second slot of the bottom piece and through the second slot of the interior piece, wherein the third piece is attachable over the top piece of the first piece with one or more fasteners, wherein the one or more fasteners are insertable into the plurality of slots of the top piece of the first piece and are also insertable into the series of slots of the third piece. In a non-limiting embodiment, a position of the second piece is adjustable in a horizontal direction, wherein a position of the third piece on the mortar correction tool is adjustable in the horizontal direction by adjusting a position of the series of slots of the third piece in the horizontal direction over the plurality of slots of the top piece of the first piece. Further, the position of the third piece is also adjustable in a vertical direction by adjusting an alignment of the vertical slit of the third piece with the plurality of slots of the top piece of the first piece, wherein the position of the third piece on the mortar correction tool is adjustable in the horizontal direction on the mortar correction tool in order to provide a leading edge on the mortar correction tool that is offset from the first piece at a distance substantially equivalent to a thickness of a corresponding piece of accent tile.

In a non-limiting embodiment, a second fastener is configured to couple the third piece over the top piece of the first piece and is configured to extend through a first slot of the plurality of slots of the top piece of the first piece through a first slot of the series of slots of the third piece, and a third fastener is configured to couple the third piece over the top piece through a second slot of the plurality of slots of the top piece of the first piece through a second slot of the series of slots of the third piece. Further, a fourth fastener is configured to extend through the first slot positioned near a top surface of the top piece of the first piece, and through the first slot that extends partially along a width of the second piece near the top surface of the second piece, and through a lower opening of the vertical slit that is perpendicular to the horizontal slit carved in the middle of the third piece.

In a non-limiting embodiment, there may be a first ruler extends along a top horizontal side of the first piece and a second ruler extends along a vertical side of the first piece, wherein the vertical side is the leading edge of the mortar correction tool. A third ruler may extend along a bottom horizontal side of the second piece and a fourth ruler extends along a vertical side of the second piece, wherein the fourth ruler is positioned on a same side as the second ruler of the first piece. In a non-limiting embodiment, wherein the first piece, the second piece, and the third piece are each rectangular shaped. The plurality of slots of the top piece of the first piece are wider than the series of slots of the third piece. Further, the thickness of the second piece is equivalent to or less than a distance of the overhang of the top piece over the bottom piece of the first piece.

In another aspect in a non-limiting embodiment, a method for using a mortar correction tool when applying accent tile. The method of providing the mortar correction tool as described above. In a non-limiting embodiment, the method may include installing a first piece of non-accent tile on a floor surface or a wall surface and installing a second piece of non-accent tile on the floor surface or the wall surface, wherein there is an accent tile gap between the first piece and the second piece of the non-accent tile, wherein the accent tile gap is configured to receive the accent tile. The method may include applying a first amount of mortar over the accent tile gap between the first piece and the second piece of the non-accent tile. The method may include measuring a thickness of the accent tile, as well as measuring a distance between a first proximate edge of the first piece of non-accent tile and a first proximate edge of the second piece of non-accent tile. The method may further include using the mortar correction tool to remove an excess amount of mortar, further comprising adjusting the mortar correction tool to be sized to reflect the thickness of the accent tile, further comprising, adjusting horizontally a third piece of the mortar correction tool that is offset a distance from a lateral side of a first piece of the mortar correction tool, wherein the distance is substantially equivalent to the thickness of the accent tile. The method may include

adjusting the mortar correction tool to be sized to reflect the distance between the first proximate edge of the first piece of non-accent tile and the first proximate edge of the second piece of non-accent tile, further comprising adjusting vertically the third piece of the mortar correction and if additional length is needed to fit the distance between the first proximate edge of the first piece of non-accent tile and the first proximate edge of the second piece of non-accent tile, further adjusting horizontally the second piece to extend past a lateral side of the second piece of the mortar correction tool. The method may further include positioning the leading edge of the mortar correction tool against the applied first amount of mortar, the leading edge of the mortar correction tool comprising at least a first leading lateral side of the top piece of the first piece, and then passing the adjusted mortar correction tool along and over the first amount of mortar and smoothing out the first amount of mortar. The method may further include, upon passing the adjusted mortar correction tool along and over the first amount of mortar, scraping or removing an excess amount of mortar from the first amount of mortar, wherein the removed excess amount of mortar is substantially equivalent to the thickness of the accent tile. The method may include applying additional layers of mortar if needed after completing the passing of the adjusted mortar correction tool over the additional layers of mortar a desired number of times, having a smoothed layer of mortar with a reduced amount of mortar from the first amount of mortar, wherein the smoothed layer of mortar has been reduced to accommodate a placing of the accent tile over the smoothed layer of mortar and has a correct amount of mortar at a desired thickness to accommodate the thickness of the accent tile.

The method may include positioning the accent tile over the smoothed layer of mortar, wherein the accent tile is evenly positioned between the first piece and the second piece of non-accent tile and does not project over or above the first piece and the second piece of non-accent tile. The method may further include contacting the first proximate edge of the first piece of non-accent tile with a top edge of the top piece of the first piece of the mortar correction tool and contacting the second edge of the second piece of non-accent tile with a bottom edge of the top piece and/or a bottom edge of the second piece while passing the adjusted mortar correction tool along and over the first amount of mortar. In a non-limiting embodiment, the removed excess amount of mortar builds up and collects on the leading edge of the mortar correction tool.

The method of may further comprise cleaning off the removed excess amount of mortar that built up or collected on the leading edge of the mortar correction tool prior to passing of the adjusted mortar correction tool over the additional layers of mortar for the desired number of times. In the method described above, in a non-limiting embodiment, a width of the second piece is equal to a width of the bottom piece of the first piece, wherein the distance between the first proximate edge of the first piece of non-accent tile and the first proximate edge of the second piece of non-accent tile is generally equivalent to a length of the accent tile. Further, in such an instance, the accent tile is positioned over the smoothed layer of mortar such that the length of the accent tile spans the distance between the first proximate edge of the first piece of non-accent tile and the first proximate edge of the second piece of non-accent tile. In the case wherein the accent tile is positioned over the smoothed layer of mortar such that the width of the accent tile spans the distance between the first proximate edge of the first piece of non-accent tile and the first proximate edge of the second piece of non-accent tile, and wherein the distance between the first proximate edge of the first piece of non-accent tile and the first proximate edge of the second piece of non-accent tile is generally equivalent to a width of the accent tile.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 depicts a pictorial illustration of a mortar correction tool for use when installing accent tile in which the components of the mortar correction tool are disassembled.

FIG. 2 depicts a pictorial illustration of a front view of an assembled mortar correction tool.

FIG. 3 depicts a pictorial illustration of a back view of an assembled mortar correction tool.

FIG. 4 depicts a pictorial illustration of a side view of an assembled mortar correction tool.

FIG. 5 depicts a pictorial illustration of an example accent tile.

FIG. 6 depicts a pictorial illustration of the assembled mortar correction tool adjusted to reflect a thickness of an accent tile.

FIG. 7 depicts a pictorial illustration of a wall surface with non-accent tile and spaces for mortar to be applied to the wall surface.

FIG. 8 depicts a pictorial illustration of an adjusted mortar correction tool positioned near a wall surface having non-accent tile.

FIG. 9 depicts a pictorial illustration of mortar applied in a thick layer to the wall surface in between the non-accent tile.

FIG. 10 depicts a pictorial illustration of commencement of smoothing out the applied mortar using the mortar correction tool.

FIG. 11 depicts a pictorial illustration of smoothing out the applied mortar using the mortar correction tool.

FIG. 12 depicts a pictorial illustration of the illustrated excess amount of mortar that is removed located on the side of the mortar correction tool.

FIG. 13 depicts a pictorial illustration of the mortar after having been completely smoothed out with a desired amount of mortar removed by the assembled mortar correction tool.

FIG. 14 depicts a pictorial illustration of the accent tile positioned over the smoothed-out mortar and between the non-accent tile on a wall surface.

FIG. 15 depicts another pictorial illustration of the installed accent tile evenly positioned between two sections of non-accent tile on a wall surface.

FIG. 16 depicts a pictorial illustration of the mortar correction tool being used on a floor surface to smooth out mortar between two pieces of non-accent tile.

FIG. 17 depicts a pictorial illustration of the smoothed-out mortar after the mortar correction tool has been used on a floor surface.

FIG. 18 depicts a flowchart for a method of using a mortar correction tool.

### DETAILED DESCRIPTION

The present description is drawn to a new and improved mortar correction tool that may be used to ensure that a correct amount and thickness of mortar is used for adhering and positioning accent tile between surrounding non-accent tile. After using the mortar correction tool in a prescribed manner, the accent tile adheres to the underlying wall and floor surface and does not project outwardly over or above the installed surrounding non-accent tile and has cleaner joints for grouting if needed because there is not an overabundance of mortar seeping through the joints of the accent tile. Any time spent in adjusting the mortar correction tool is worthwhile to minimize time needed to correct wrong amounts of mortar applied between pieces of non-accent tile using conventional methods that do not include the use of a mortar correction tool. Additional details are provided with respect to the Figures.

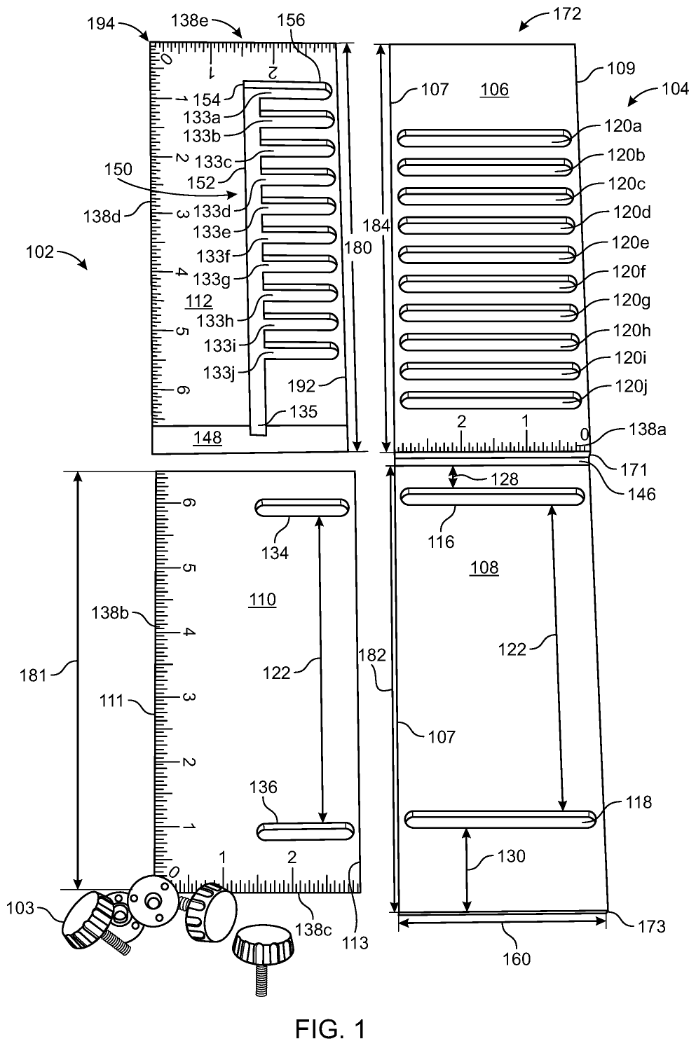

FIG. 1 shows a dissembled mortar correction tool 102. In a non-limiting embodiment, the mortar correction tool 102 includes three main pieces which are first piece 104, a second piece 110, and a third piece 112 as shown in FIG. 1. The first piece 104 is composed of a top piece 106 and a bottom piece 108 in one or more non-limiting embodiments.

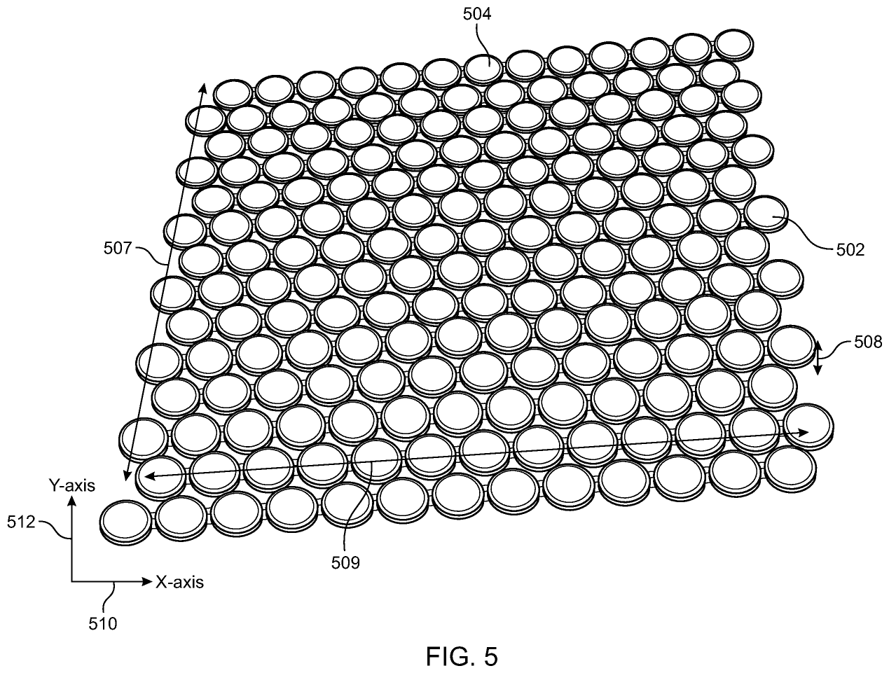

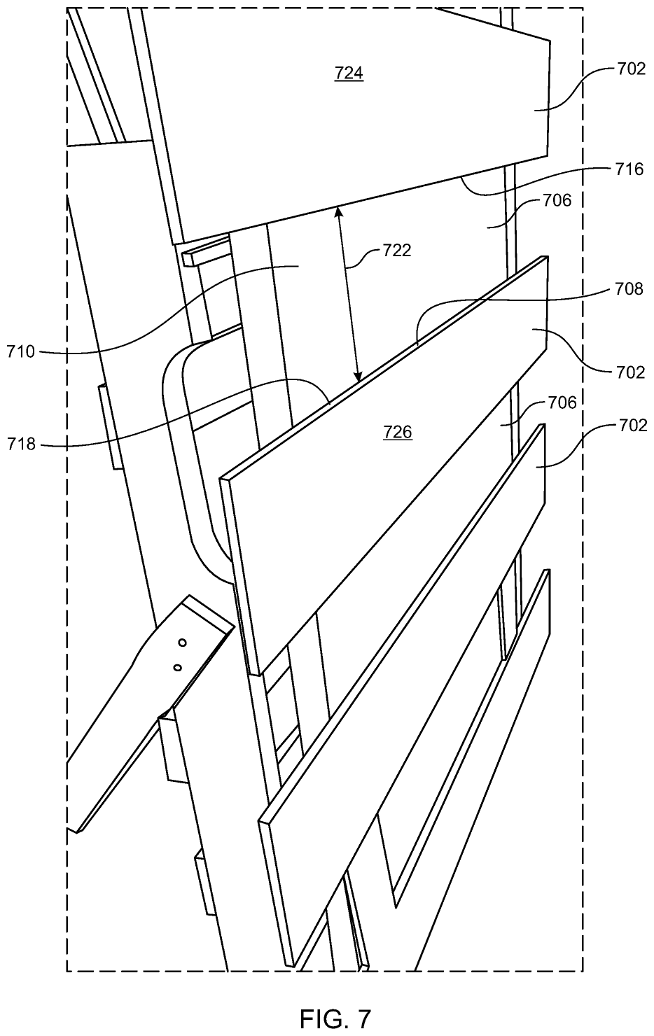

The top piece 106 of the first piece 104 may include a plurality of slots 120a-j that are spaced apart from each other in equal amounts. In a non-limiting embodiment, there may be ten slots, namely, slots 120a, 120b, 120c, 120d, 120e, 120f, 120g, 120h, 120i, and 120j as shown in FIG. 1. In a non-limiting exemplary embodiment, the slots may be 0.25 inches long and may be spaced 0.25 inches apart from each other. One of ordinary skill in the art comprehends that other dimensions are substitutable and these dimensions are exemplary. Indeed, the size of the components of the mortar correction tool 102 may be scaled to be larger or smaller as needed to suit the size of the non-accent tile (e.g., non-accent tile 702 as shown in FIG. 7) and the accent tile (e.g., accent tile 502 as shown in FIG. 5). A ruler 138a may extend horizontally along a bottom edge 171 of the top piece 106 of the first piece 104 in one or more non-limiting embodiments. The ruler 138a may include numbers and markings to allow a user to make measurements using the ruler 138a. As shown in FIG. 1, in a non-limiting embodiment, the ruler 138a may extend up to 3 inches wide from a left edge 107 to a right edge 109 of the top piece 106 of the first piece 104 of the mortar correction tool 102.

As noted above, in a non-limiting embodiment, the first piece 104 includes a bottom piece 108 as shown in FIG. 1. The bottom piece 108 may include a top slot 116 and a bottom slot 118, also referred to herein as a first slot 116 and a second slot 118 of the bottom piece 108 of the first piece 104. In a non-limiting embodiment, the first slot 116 is positioned near to and a distance 128 from a top surface of the bottom piece 108. The second slot 118 is positioned near to and a distance 130 from the bottom surface of the bottom piece 108. The first slot 116 and the second slot 118 are spaced a distance 122 apart as well.

The first slot 116 and the second slot 118 of the bottom piece 108 may extend substantially in a lateral or horizontal direction through a body of the bottom piece 108, but do not extend fully from a left side 107 to a right side 109 of the bottom piece 108. Rather, the first slot 116 and the second slot 118 of the bottom piece 108 are carved or otherwise formed within the body of the bottom piece 108 and terminate just before reaching a left side 107 or right side 109 of the bottom piece 108.

In a non-limiting embodiment, the top piece 106 is fixedly connected to the bottom piece 108 of the first piece 104 of the mortar correction tool 102 in one or more non-limiting embodiments. “Fixedly connected” as used herein may mean fixed in place and not easily removed or taken apart without breaking off one or more elements of the top piece 106 or bottom piece 108 in an undesirable manner.

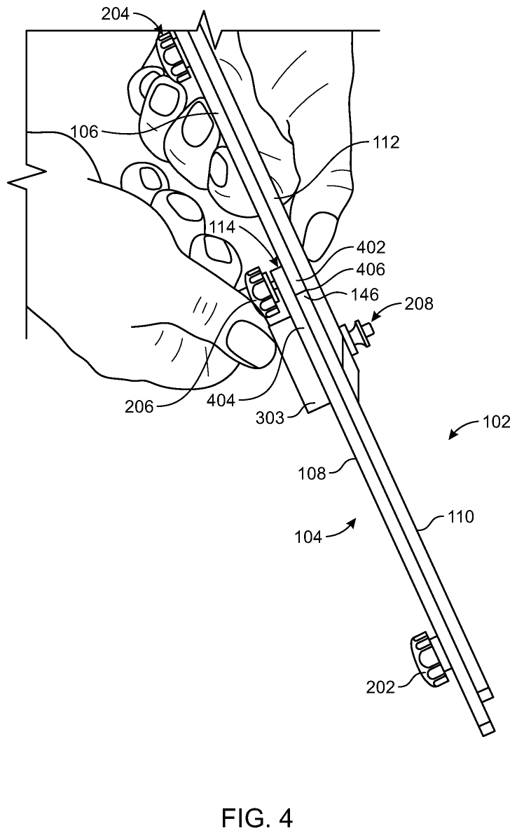

Accordingly, the top piece 106 may be fixedly connected to the bottom piece 108 at a joint 114 found on a backside of the mortar correction tool 102, as also shown in FIG. 4 in the side assembled view of the mortar correction tool 102, between the top piece 106 and the bottom piece 108. It is noted in other non-limiting embodiments, the top piece 106 may be removably connected or attached to the bottom piece 108 and can be removably connected with fasteners, magnets, or other means of attachment.

The first piece 104 extends from the top edge 172 of the top piece 106 to the bottom edge 173 of the bottom piece 108, whereby, as noted above, the top piece 106 and the bottom piece 108 are fixedly or removably connected to each other.

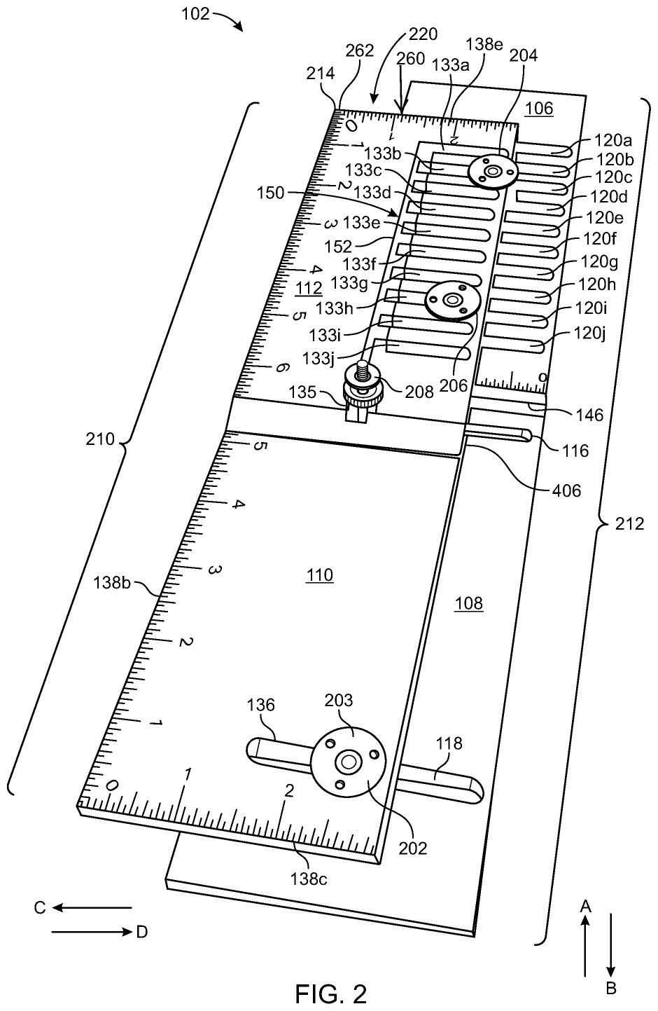

As shown in the side view of the assembled mortar correction tool 102 shown in FIG. 4, in a non-limiting embodiment, a lower surface 402 of the top piece 106 is fixedly attached onto an upper area 404 of a front side of the bottom piece 108, which is also shown in FIG. 4. Further, an overhang 146, as shown in FIG. 1 and in FIG. 4, exists or is formed by this arrangement whereby a lower surface 402 of the top piece 106 is fixedly attached onto and over an upper surface 404 of the front side of the bottom piece 108. Accordingly, the top piece 106 of the first piece 104 is offset or overhangs 146 over the bottom piece 108 of the first piece 104 as shown in FIG. 4. In a non-limiting embodiment, the overhang 146 is at least equivalent or greater than a thickness of the second piece 110. This may be because the second piece 110 is designed to be coupled with fasteners (e.g., fasteners 202 and 208) and fit onto and over the bottom piece 108 and fit under the overhang 146, as also shown in FIG. 4. The top piece 106 and bottom piece 108 may be designed in such a manner to ensure that the second piece 110 can be positioned onto and over the bottom piece 108 of the first piece 104. A top edge 406 of the bottom piece 110 may contact the overhang 146 (i.e., the underside of the top piece) when the bottom piece 110 is positioned in place with one or more fasteners, such as first fastener 202 and fourth fastener 208 as shown in FIG. 2 and in FIG. 4. In a non-limiting embodiment, the overhang 146 may be at least 0.25 inches long, which may correspond to and be the same as a thickness of the second piece 110 in one or more non-limiting embodiment.

As noted above, the mortar correction tool 102, as shown in its disassembled arrangement in FIG. 1, includes a second piece 110. The second piece 110, as shown in FIG. 1, may include a first slot 134 and a second slot 136. As shown in FIG. 1, the first slot 134 and second slot 136 of the second piece 110 may be spaced a same distance apart 122 as the first slot 116 and the second slot 118 of the bottom piece 108 of the first piece 104. Further, the first slot 134 and second slot 136 of the second piece 110 may be smaller than the size of the first slot 116 and the second slot 118 of the bottom piece 108 of the first piece 104 of the mortar correction tool 102 in a non-limiting embodiment. In a non-limiting embodiment, the first slot 134 and the second slot 136 of the second piece 110 may be approximately half the size of the first slot 116 and the second slot 118 of the bottom piece 108 of the first piece 104 of the mortar correction tool 102. Further, it is noted that as shown in FIG. 1, the first slot 134 is positioned above the second slot 136 and separated by a distance 122. As also shown in FIG. 1, the first slot 116 of the bottom piece 108 of the first piece 104 is positioned above the bottom slot 118 of the bottom piece 108 of the first piece 104 and is separated by the same distance 122 in a non-limiting embodiment.

For the second piece 110, the top or first slot 134 and the bottom or second slot 136 may not extend fully to the right side 113 of the second piece 110, but rather may end before reaching the right side 113 of the second piece 110. The left side 111 of the second piece 110 may be further away from the first slot 134 and the second slot 136 than the right side 113 of the second piece 110 as also shown in FIG. 1.

At a bottom surface of the second piece 110, there may be a ruler 138b with one or more markings and spaces to indicate numbers and measurements. Any ruler 138 shown on the mortar correction tool 102, including rulers 138a, 138b, 138c, 138d, and 138e, may be configured to accommodate to reflect any commonly known measuring system, without limitation, to the metric system or the imperial (English) system. The rulers 138, including ruler 138b on the bottom horizontal edge of the second piece 110 may be drawn on, printed, engraved, or otherwise included at or just above the bottom surface of the second piece 110. The second piece 110 further include another ruler 138b, shown in FIG. 1, that extends vertically along the left side edge 111 of the second piece 110 and extends along the full length 181 of the second piece 110. In a non-limiting embodiment, the ruler 138b may be about 6 or 6½ inches in length.

As shown in FIG. 1 and throughout, the mortar correction tool 102 further includes a third piece 112. In a non-limiting embodiment, the third piece 112 may include a backwardly oriented L-shaped slot or slit 150. The backwardly oriented L-shaped slot or slit 150 may include a vertical slit 152 that is perpendicularly oriented to a horizontal slit 156 and joined at the perpendicular joint 154 as shown in FIG. 1. The third piece 112 may further include an angled slope piece 148 at a bottom surface of the third piece 112. The third piece 112 may include a left side 190 and a right side 192.

The vertical slit 152 of the L-shaped slot 150 may begin a distance below the top edge 194 of the third piece 112 and below the ruler 138e and extend in a downward direction. In a non-limiting embodiment, a terminal portion 135 of the vertical slit 152 may extend through some portion of the angled slope piece 148 as shown in FIG. 1 in a non-limiting embodiment. Further, the horizontal slit 156 may stop or terminate before reaching a right side 192 of the third piece 112. The backwardly oriented L-shaped slit 150 may terminate before reaching the bottom (lowermost) edge 196 of the third piece 112. In a non-limiting embodiment, the third piece 112 may further include a ruler 138d extending along the left vertical side 190 of the third piece 112. In a non-limiting embodiment, the ruler 138d extending along the left vertical side 190 of the third piece 112 is 6.5 inches and the length of the angled slope 148 may be approximately another 0.5 inches making the total length 180 of the third piece 112 about 7 inches long.

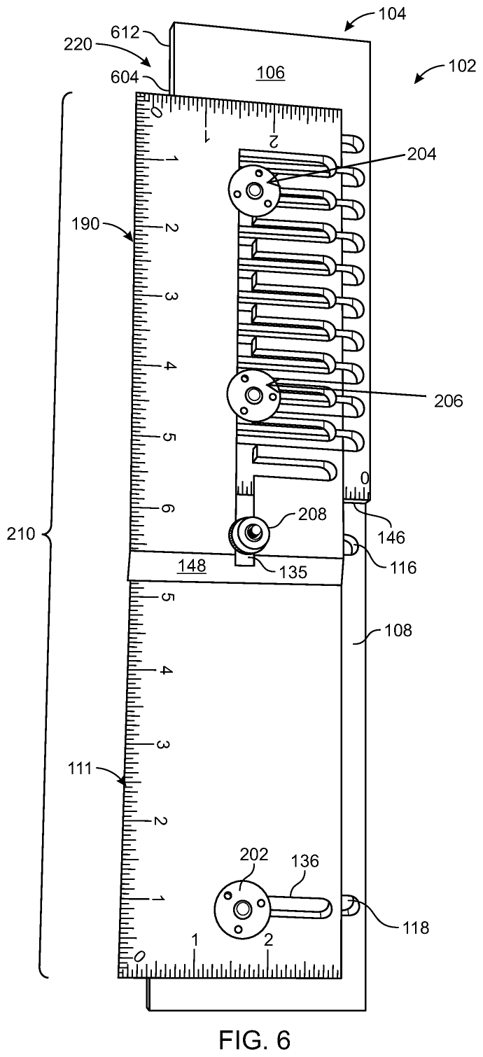

As shown in FIG. 1, FIG. 2, and FIG. 6, and elsewhere in the drawings, the third piece 112 may further include a series of vertically spaced apart slots 133 that are part of the backwardly oriented L shaped slot 150. The series of slots 133, as shown in FIG. 1 and elsewhere, in a non-limiting embodiment, include at least 10 slots, namely, 133a, 133b, 133c, 133d, 133e, 133f, 133g, 133h, 133i, and 133j. These series of slots extend horizontally away from the vertical slit 152 of the backwardly oriented L shaped slot 150 and terminate before reaching a right side 192 of the third piece 112 as shown in FIG. 1. In a non-limiting embodiment, the diameter of the series of slots 133 in the third piece 112 may be approximately equivalent to the diameter of the series of slots 120 in the top piece 106 of the first piece 104. Further, the distance between each slot 133 in the third piece 112 may be approximately equivalent to the distance between each slot 120 in the top piece 106 of the first piece 104. In a non-limiting embodiment, the diameter of the slots 133 in the third piece 112 and the diameter of the slots 120 in the top piece 106 may be approximately .25 inches, and the distance between the slots 133 in the third piece 112 and the distance between the slots 120 in the top piece 106 may also be approximately 0.25 inches. Further, the length of the slots may be approximately 2.5 inches. In a non-limiting embodiment, the width 160 of the top piece 106, bottom piece 108, second piece 110, and third piece 112 may all be at least 3 inches wide, although this measurement is exemplary only.

The series of slots 133 that extend away from the backwardly oriented L shaped slot 150 may be such that they allow the third piece 112 to be shifted or slidably adjusted in a horizontal direction either to the left, as shown by the arrow C in FIG. 2 or to the right, as shown by the arrow D in FIG. 2. The series of slots 133a-133j on the third piece 112 are positioned and arranged to align (laterally and vertically) with the series of slots 120a-120j of the top piece 106 of the mortar correction tool 102, so that these slidable adjustments in a left or right horizontal direction can be made for the third piece 112 when connected (e.g., via fasteners 103 as shown in FIG. 1 and more specifically fasteners 202, 204, 206, and 208 as shown in FIG. 2) to the top piece 106 of the mortar correction tool 102.

Further, the third piece 112 can be manipulated to move in a vertical direction either in an upward direction as indicated by arrow A shown in FIG. 2 or in a downward direction as indicated by arrow B as shown in FIG. 2 to further position the third piece 112 to create an offset 220, as shown in FIG. 2 and further explained below.

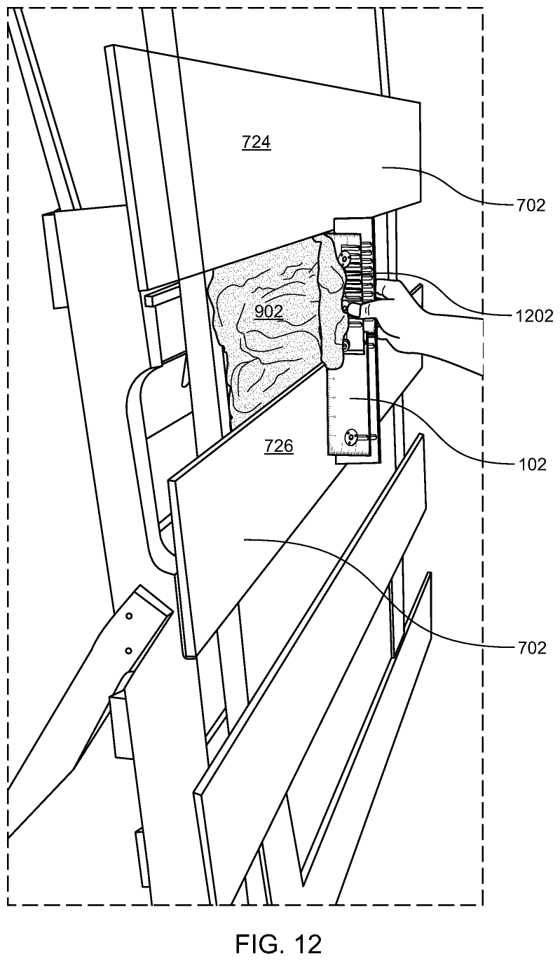

In a non-limiting embodiment, the top piece 106 and the bottom piece 108 of the first piece 104, the second piece 110, and the third piece 112 may all be rectangular shaped. The rectangular shape of the first piece 104, the second piece 110, and the third piece 112 of the mortar correction tool 102 may be useful to provide straight edges that can be used to correctly scrape off excess amounts of mortar (e.g., excess mortar 1202 shown in FIG. 12). In other non-limiting embodiments, any other shapes may be used. In a non-limiting embodiment, the first piece 104 including the top piece 106 and the bottom piece 108, the second piece 110, and the third piece 112 may be manufactured having the same width 160 as shown in FIG. 1.

FIG. 1 shows a general assortment of fasteners 103 that are disassembled and may be used in their assembled form to couple the components 104, 110, and 112 of the mortar correction tool 102 together. FIG. 2 includes further details regarding the fasteners 103 and preferred positions.

In a non-limiting embodiment, a preferred length 180 of the third piece 112 may be about 7 inches long and the length 181 of the second piece 110 may be about 6 inches long. Further, in a non-limiting embodiment, the length 184 of the top piece 106 of the first piece 104 may be 7 inches long in a non-limiting embodiment, while the length 182 of the bottom piece 108 of the first piece 104 may be 7½ inches long and. As noted above, in a non-limiting embodiment, the slots 120a-120j of the top piece 106 of the first piece 104 may be spaced at least 0.25 inches apart. In other embodiments, this tool 102 may also may be used for accent tile smaller than 7 inches or for other sized tile, such as 2×12 inch tile, and the mortar correction tool 102 may be sized to accommodate other tile sizes.

In a non-limiting embodiment, the components of the mortar correction tool 102 may be manufactured from wood, metal, plastic, or any desired material. Advantageously, the mortar correction tool 102 may be lightweight and easily transported from place to place. Further, many of the components may be disassembled and taken apart for easy cleaning or storage if needed or the mortar correction tool 102 may be stored in its assembled state.

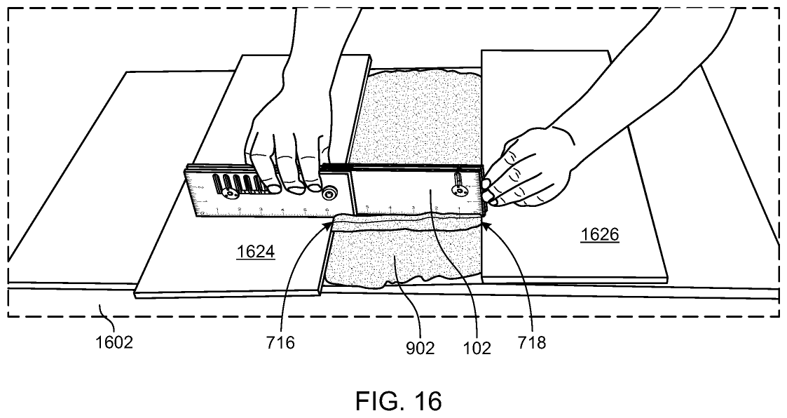

FIGS. 2-4 and FIG. 6 illustrate the mortar correction tool 102 in its assembled position. More specifically, FIG. 2 shows a front view of the mortar correction tool 102 with the components of the mortar correction tool 102 arranged as such in a forward facing manner so that a leading edge 210 of the mortar correction tool 102 is formed. In a non-limiting embodiment, the leading edge 210 is also the scraping edge of the mortar correction tool 102 that directly scrapes off any mortar 902 between a first piece 724, 1624 of non-accent tile 702 and a second piece 726, 1624 of non-accent tile 702 (e.g., as shown in FIG. 7 and in FIG. 16). In a non-limiting embodiment, the leading edge 210 may span from a top corner edge 214 located on an upper left edge of the third piece 112 to a bottom corner edge 218 located on a bottom lower left edge of the second piece 110.

In a non-limiting embodiment, the leading edge 210 of the mortar correction tool 102 may solely comprise the left side edge 190 of the third piece 112 that is spaced away from the left edge 107, as shown in FIG. 1, by an amount equal to the offset 220 as shown in FIG. 2. In other non-limiting embodiments, the leading edge 210 of the mortar correction tool 102 may include both the left side 190 of the third piece 112 and the left side 111 of the second piece 110 of the assembled mortar correction tool 102. In some cases, solely the third piece 112 is jutting horizontally away from the top piece 106 and bottom piece 108 of the first piece 104 and the left side 190 of the third piece 112 provides the leading edge 210, but in other cases, the leading edge 210 includes the left side 111 of the second piece 110. The length of the leading edge 210 and whether the second piece 110 is jutting out horizontally away from the bottom piece 108 of the first piece 104 depends upon the length of the distance 722 between a first piece 724,1624 of non-accent tile 702 and a second piece 726,1626 of non-accent tile 702 as shown in FIG. 7 and in FIG. 16, and specifically the distance between a bottom edge 716 of the first piece 724 , 1624 of non-accent tile 702 and a top edge 718 of the second piece 726,1626 of non-accent tile 702. The assembled mortar correction tool 102, as shown in FIG. 2, may further include a trailing edge 212 opposite the leading edge 210.

As shown in FIG. 2, the top piece 106 is fixedly connected to the bottom piece 108 of the mortar correction tool 102, and the overhang 146 of the first piece 104 is shown in FIG. 1. The second piece 110 fits over the bottom piece 108 of the first piece 104 of the mortar correction tool 102 as shown in FIG. 1 such that a top edge 406 of the second piece 110, as shown in FIG. 2 and in FIG. 4, makes contact with the overhang 146 of the top piece 106.

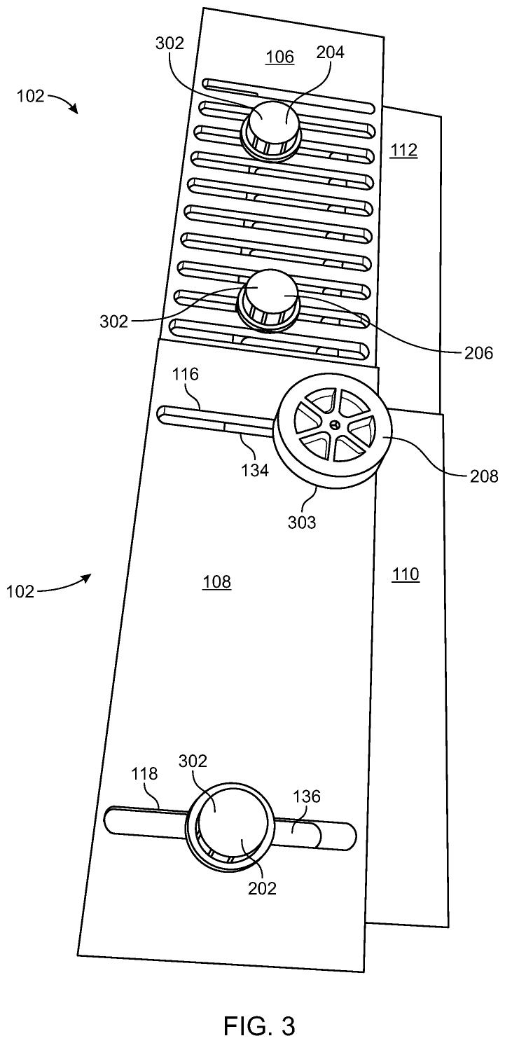

As shown in FIG. 2, a number of fasteners 103 or fastener sets may be used to couple the third piece 112 to the top piece 106 and the bottom piece 108 (e.g., at 135 of the third piece 112) and to couple the second piece 110 to the bottom piece 108 of the first piece 104 of the mortar correction tool 102. The fasteners 103, which include first fastener 202, second fastener 204, third fastener 206, and fourth fastener 208 in one or more non-limiting embodiments, may include one or more washers 203 as shown in FIG. 2. Washers 203 may be circular flat discs with openings configured to receive a threaded screw or bolt. In a non-limiting embodiment, each fastener set 202, 204, 206, and 208 may include one or more screws or bolts 302, as shown in FIG. 3, that may further affix to a washer 203. Further, FIG. 3 shows how in a non-limiting embodiment, the cover 303 for the fastener 208 may be much wider or larger than covers for the other screws or bolts 302 in one or more non-limiting embodiments. It is intended that a user may easily affix the third piece 112 where needed and the second piece 110 where needed on the top piece 106 and bottom piece 108, respectively, of the first piece 104 using fasteners 103 that can easily be turned using one's fingers so as to make minor adjustments to the positioning of the third piece 112 and/or second piece 110 of the mortar correction tool 102. It is noted that any type of fasteners as needed may be used other than those shown in FIG.2 and in FIG. 3.

As shown in FIG. 2, a first fastener 202 is used to couple the second piece 110 to the bottom piece 108, whereby a first fastener 202 is insertable through the second slot 136 of the second piece 110 and into the second slot 118 of the bottom piece 108 of the first piece 104 of the mortar correction tool 102 according to one or more non-limiting embodiments.

A second fastener 204, as labeled in FIGS. 2-4, may extend through one of the slots 120 of the top piece 106 of the first piece 104 and also through one of the slots 133 of the third piece 112. The user can adjust the position of the second fastener 204 to allow the third piece 112 to slide right or left or up or down and can tighten or loosen the second fastener 204 (or any of the fasteners 202, 204, 206, and 208 described herein) as needed.

Further, as shown in FIGS. 2-4, a third fastener 206 may extend through another slot 120 of the top piece 106 of the first piece 104 of the mortar correction tool 102 and also through another slot 133 of the third piece 112 in one or more non-limiting embodiments. As shown in FIG. 1-4, the second fastener 204 and the third fastener 206 can function to extend through the slots 120 of the top piece 106 and into the aligned slots 133 of the third piece 112 to fastenably couple the top piece 106 of the first piece 104 and the third piece 112 together. Accordingly, the user selects the position of the second fastener 204 and the third fastener 206 to properly position the third piece 112 over the top piece 106 and align the slots 133 of the third piece 112 with the slots 120 of the top piece 106 of the first piece 104 of the mortar correction tool 102.

A fourth fastener 208 is shown in FIGS. 2-4, whereby the fourth fastener 208 extends through a backside of the bottom piece 108 of the first piece 104, and specifically through a top first slot 116 of the bottom piece 108 and through a portion of the vertical slit 152. As shown in FIG. 2, the fourth fastener 208 may in some instances extend through the top first slit 116 of the bottom piece 108 into the terminal portion 135 of the vertical slit 152 as shown in FIG. 2. Accordingly, the sets of fasteners 202, 204, and 206 allow the second piece 110 and the third piece 112 to be fastened in a selected horizontal orientation or position with respect to the bottom piece 108 and top piece 106 of the first piece 104, while the fourth fastener 208 serves to allow the third piece 112 to be fastened in a selected vertical orientation or position with respect to the top piece 106 of the third piece 112 as well as the bottom piece 110. As noted above, the third piece 112 is intended to be slidably adjustable over the top piece 106 and the second piece 110 is intended to be slidably adjustable over the bottom piece 108, and the fasteners 202, 204, 206, 208 hold the positions of the desired arrangement. As further explained below, the function of the third piece 112 is to create a scraping edge via the leading edge 210 that is offset 220 in an amount equivalent to a thickness 508 of accent tile 502. Further, an additional purpose or function for the third piece 112 is to provide a leading edge 210 for scraping off a desired amount of mortar 902.

The ruler 138e shown on the third piece 112 may usefully be used to measure a distance that the third piece 112 has to be offset 220 from the top piece 106 and/or to measure a distance that the bottom piece 110 has to be offset 220 from the bottom piece 108. Further, the ruler 138 may also be helpful to horizontally align the second piece 110 so that the second piece 110 is straight with the third piece 112 when offset 220 from the top piece 106 and the bottom piece 108. The user may know that the second piece 110 is straight when the numbers on the ruler 138c are in alignment with the numbers on the ruler 138e for the third piece 112. It may be important that the leading edge 210 has a straight edge to make sure the correct amount of mortar 902 is scraped off equivalent to the offset 220.

FIG. 3 shows a back view of the mortar correction tool 102 with the second piece 110 connected to the back surface of the bottom piece 110, and the top piece 106 coupled to the third piece 112, all with the use of one or more fastener sets 202, 204, 206, and 208, as also shown in FIG. 2 and in FIG. 4. It is noted that FIG. 3 shows an example position or location of the third piece 112 and the second piece 110, because the third piece 112 and the second piece 112 are meant to be horizontally adjustable by manipulating a position of the third piece 112 series of slots 133 as aligned horizontally with the series of slots 120 of the top piece 106 of the first piece 104, and/or manipulating the positioning of the slots 134, 136 of the second piece 110 as aligned over the slots 116 and 118 of the bottom piece 108 of the first piece 104 of the mortar correction tool 102.

The third piece 112 may also be vertically adjustable. The third piece 112 can be connected wherever needed in a vertical direction by engaging the fastener sets 204, 206, and 208 in one or more slots of the first piece 104 and the second piece 110 to provide an adequate length and to reflect a thickness 508 of a corresponding piece of accent tile, such as the accent tile 502 shown in FIG. 5.

FIG. 4, as noted above, provides a side view of the assembled mortar correction tool 102 showing the order and positioning of the first piece 104 (and its sub-components, top piece 106 and bottom piece 108), the second piece 110, and the third piece 112 when fastenably coupled or connected together via fastener sets 202, 204, 206, and 208. It is noted more or less fasteners than those shown in FIGS. 2-4 may also be utilized in one or more other non-limiting embodiments.

The ability to adjust the vertical and horizontal placement of the third piece 112 in conjunction with the other components of the mortar correction tool 102 (e.g., first piece 104 and second piece 110) is useful so that the mortar correction tool 102 is able to mirror and reflect the key dimensions of a corresponding piece of accent tile, such as the exemplary accent tile 502, shown in FIG. 5. Further, the second piece 110 can also be adjusted laterally so that the top slot 134 and bottom slot 138 of the second piece 110 can be positioned where needed to form a correct leading edge 210.

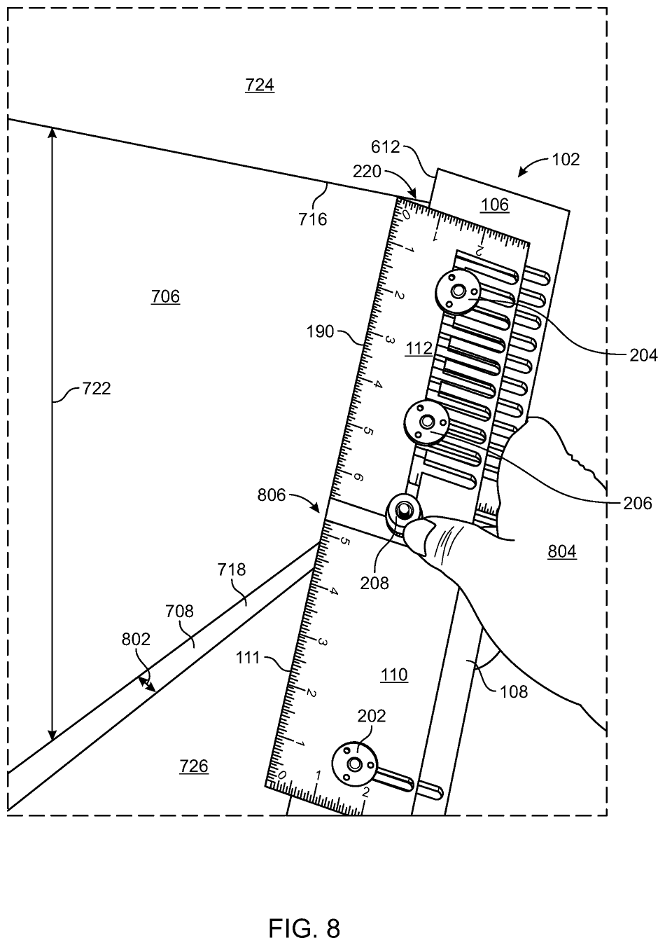

The third piece 112 of the mortar correction tool 102 may need to be extended down on the mortar correction tool 102 to be positioned over and to align its backwardly oriented L-shaped slit 150 and series of slots 133a-j with one or more slots 120a-j of the third piece 112 if the length 507 of the accent tile 502, as shown in FIG. 5, exceeds the length 184, as shown in FIG.1, of the top piece 106 of the first piece 104 of the mortar correction tool 102, as further explained below with reference to FIG. 8. Notably, the length of the leading edge 210 needs to accommodate the distance 722, as shown in FIG. 7 between a first piece 724 of non-accent tile 702 and a second piece 726 of non-accent tile 702 as well as the orientation of the accent tile 502. In some cases, the accent tile 502 is intended to be installed so that the length 507 of the accent tile 502 extends between the distance 722 between the first and second piece 724, 726 of non-accent tile 702 (e.g., as shown in FIG. 7). In other cases, the accent tile 502 is intended to be installed so that the width 509 of the accent tile 502 extends between the distance 722.

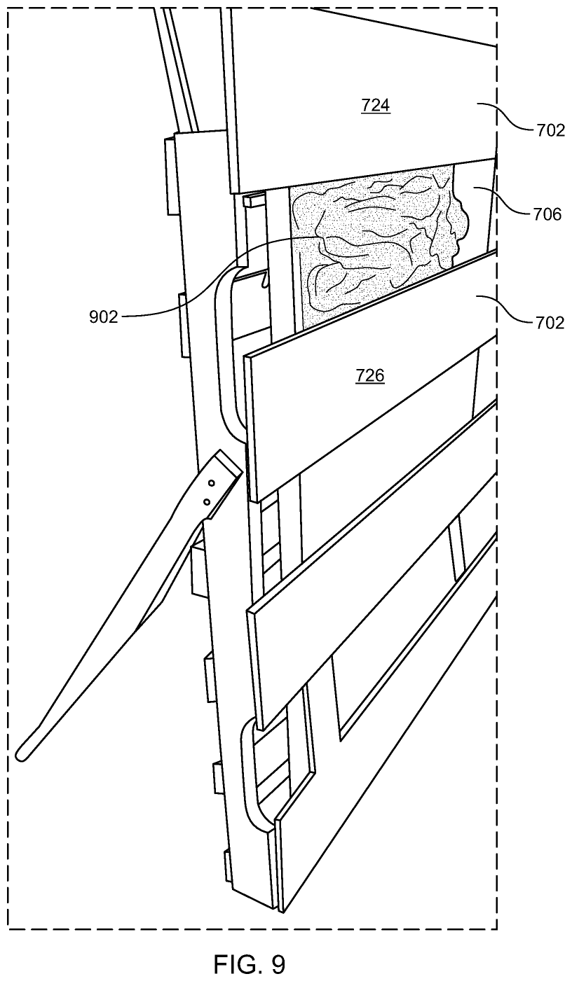

As further explained below, the leading edge 210 of the assembled mortar correction tool 102 is the edge of the mortar correction tool 102 used to scrape off or remove any excess amount of mortar (e.g., excess mortar 902 shown in FIG. 9). The trailing edge 212 is the opposite edge of the assembled mortar correction tool 102 from the leading edge 210.

FIG. 5 shows an exemplary piece of accent tile 502. Accent tile 502 may be made up of various accent tile elements 504 and can be arranged in many different ways. Accent tile 502 may have multiple accent tile elements 504 arranged in horizontal rows, vertical rows, and/or in angled or asymmetrical orientations. As noted above, it is common for accent tile 502 to be made from and to include a variety of materials, such as, but not limited to, ceramic, porcelain, colorful glass, stone, travertine, beads, and shells. Accent tile 502 may be a uniform color or may have multiple colored accent tile elements 504 arranged together, whereby the accent tile elements 504 each have the same or different shape and/or orientation. Accent tile 502 is frequently sold by stores or manufacturers as sections of linear feet of accent tile 502 whereby the accent tile elements 504 are already attached to each other and can be purchased in specific amounts of linear feet. The accent tile elements 504 may be connected together and firmly attached to a backing piece of material holding the accent tile elements 504 together so that a contractor or technician does not have to connect or piece together many accent tile elements 504 to each other and/or to a wall surface or floor surface. There are usually open seams between each tile element 504 that the user can later fill with caulking when the accent tile 502 has been fully installed.

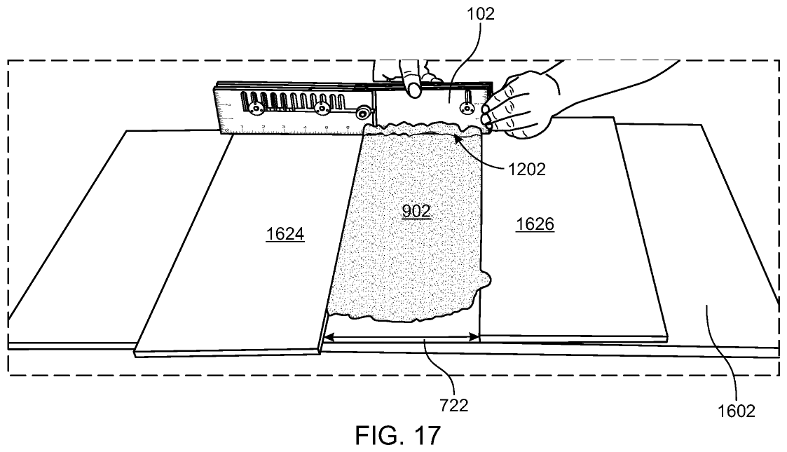

Some important dimensions may be measured for each section of accent tile 502 to be installed on a wall or floor surface. The contractor or technician installing the accent tile 502 to a wall surface, such as wall surface 710 shown in FIG. 7, or to a floor surface, such as floor surface 1602 shown in FIGS. 16-17, may want to take the measurements of the length 507 of the accent tile 502 and the thickness 508 of the accent tile 502 in particular. The width 509 of the accent tile 502, as used herein, may refer to the area of accent tile 502 that extends along in a horizontal direction along the X-axis 510 and the length 507 may refer to the area of the accent tile 502 that extends in a vertical direction along the Y-axis 512, as shown in FIG. 5.

Notably, the various parts or components of the mortar correction tool 102 as mentioned above and shown in FIGS. 1-4 may be adjusted to reflect a length 507 and/or width 509 of the corresponding piece or section of accent tile 502 depending on the positioning and orientation of the accent tile 502 to be installed between a first piece 724 of non-accent tile 702 and a second piece 726 of non-accent tile 702, as shown in FIG. 7. Further, the various parts or components of the mortar correction tool 102, as mentioned above and shown in FIGS. 1-4, may be adjusted to reflect a thickness 508 of the corresponding piece or section of accent tile 502. In order to obtain these measurements, in some instances, it may be useful to also use any type of measuring tool, such as, but not limited to, a tape measure may be used to measure the width 509, length 507 and thickness 508 of the accent tile 502. That being said, when the user knows the dimensions of each component 104, 110, and 112 of the mortar correction tool 102, and the mortar correction tool 102 includes one or more rulers 138a-138e, the user can also use such rulers 138a-138e with the user's knowledge of the dimensions to properly position and adjust the components of the mortar correction tool 102 to reflect the proper length 507 and/or width 509 of the accent tile 502 and notably, the thickness 508 of the accent tile 502. As noted above, the mortar correction tool 102 may usefully be used to scrape off a precise amount of mortar 902 so that only a desired amount of mortar is left behind that leaves enough room for the thickness 508 of the accent tile 502 to fit over that remaining mortar so that the accent tile 502 is flat and level with the floor 1602 (e.g., as shown in FIG. 16) or wall surface 710 (e.g., as shown in FIG. 7) and does not jut out over the floor or wall surface.

FIG. 6 shows the assembled mortar correction tool 102 adjusted to reflect the thickness 508 of accent tile 502. FIG. 6 shows a view of the front side of the assembled correction tool 102 with a close up-view of the top piece 106 of the first piece 104 connected to the third piece 112 and the second piece 110 connected with fasteners (e.g., 202, 204, 206, and 208) to the bottom piece 108 of the first piece 104.

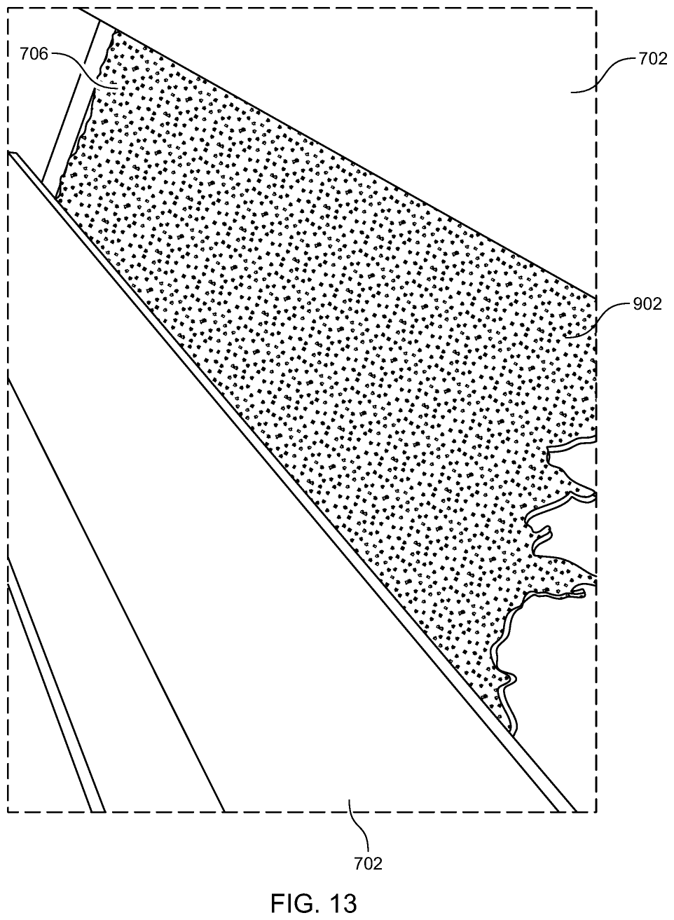

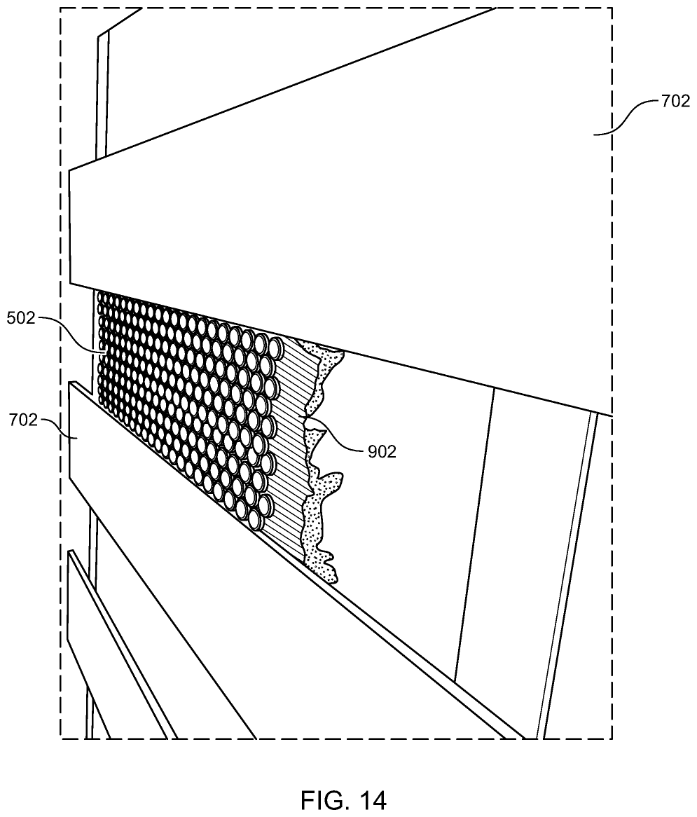

To adjust the assembled mortar correction tool 102 to reflect the thickness 508 of accent tile 502, the contractor or other user has to position the components of mortar correction tool 102 together in such a way that the slots 120 on the top piece 106 align with the slots 133 of the third piece 112, and then position the third piece 112 laterally or in a horizontal direction in order to create an offset 220 whose distance from the top edge of the top surface 172 of the top piece 106 reflects a thickness 508 of the accent tile 502. Accordingly, the offset 220 has to have the same measurement as the measurement obtained for the thickness 508 of the accent tile 502. Notably, the distance from point 260 on the third piece 112 to 262 on the third piece 112 represents the offset 220 and also the measurement obtained for the thickness 508 of the accent tile 502. The leading edge 210 as composed of at least side 190 of the third piece 112 and possibly even side 111 of the second piece 110 is intended to contact the mortar 902 at least the distance of the offset 220 and the distance from point 260 to point 262 as shown in FIG. 2. That is so that the mortar correction tool 102 can function as a scraping tool that has been calibrated or adjusted to reflect the proper thickness 508 of the accent tile 502 in order to enable the user to position the accent tile 502 over a smooth surface of mortar 902 that leaves enough space for the thickness 508 of the accent tile 502 to fit over the smoothed surface of mortar 902 (e.g., as shown in FIG. 13 and in FIG. 14).

As noted above, the user can use the ruler 138e of the third piece 112 if needed to measure the thickness 508 of the accent tile 502 and then position the ruler 138 to have the desired offset 220, and then lock the fasteners 204, 206, and 208 in place to lock in the offset 220. Alternatively, the user does not have to use the ruler 138e to measure the thickness 508 of the accent tile 502. As noted above, the user may utilize another measuring tool, like a separate ruler or tape measure.

In addition to the above, when the offset 220 is formed by the user laterally adjusting the third piece 112, the third piece 112 will project laterally farther out than the corresponding side 107 of the top piece 106 of the first piece 104 of the mortar correction tool 102. This may cause what appears as a perpendicular 604 oriented offset 220 between the top piece 106 and the attached third piece 112. This perpendicular oriented 604 offset 220 shown in FIG. 6 and in FIG. 8 may be the element of the mortar correction tool 102 that creates a “scraper edge” that can scrape off a desired amount of mortar 902 applied to a wall surface 710, as shown in FIG. 7, or floor surface 1602, as shown in FIG. 16, whereby the desired amount of mortar 902 to be scraped off reflects the thickness 508 of a corresponding piece of accent tile 502. The offset 220 includes a vertical edge 612 as shown in FIG. 6, that is part of the exposed part of the lateral side 107 of the top piece 106 of the first piece 104 of the mortar correction tool 102. This vertical edge 612 of the offset 220 can be positioned against piece of surrounding non-accent tile 702 (e.g., as shown in FIG. 8) to help with the scraping of the correct amount of mortar 902.

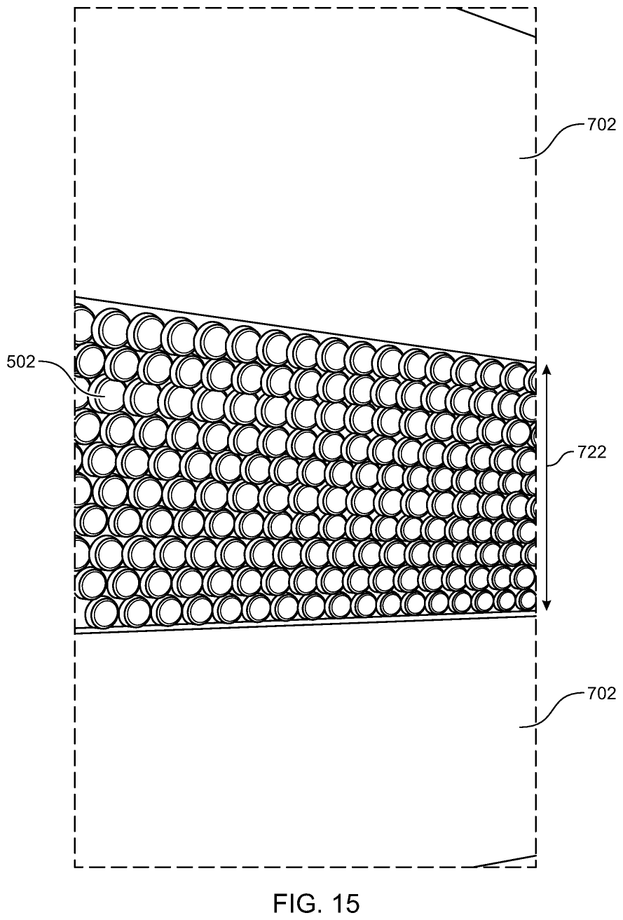

FIG. 7 shows an example installation of non-accent tile, such as non-accent tile 702, on wall surface 710. The non-accent tile 702 is any tile 702 that is visually different and distinguishable from the accent tile 502. Typically, accent tile 502 has a thinner thickness 508 than the thickness 802, as shown in FIG. 8, of the non-accent tile 702. Accordingly, the contractor has to take into account that when the contractor wants to position the accent tile 502 between the surrounding non-accent tile 702, that the contractor has to put a limited quantity of mortar 902 and still leave enough room for the specific thickness of the accent tile 502 while not causing the accent tile 502 to jut or project over or outwardly past the surrounding non-accent tile 702, because the accent tile 502 needs to be level with the non-accent tile 702 and not project past the non-accent tile 702 (e.g., which is shown in FIG. 15) after a correct installation of the accent tile 502 between the surrounding non-accent tile 702 using the mortar correction tool 102. The contractor needs to ensure that the accent tile 502 has the same depth when attached to a wall or floor surface as a first piece 724 of non-accent tile 702 and a second piece 726 of non-accent-tile 702 positioned on either side of the accent tile 502, whether the accent tile 502 is horizontally or vertically oriented.

FIG. 7 shows a first piece 724 of non-accent tile 702 positioned above a gap 706 and a second piece 726 of non-accent tile 702 beneath the gap 706. Other pieces of non-accent tile 702 are also shown in FIG. 7 as the non-accent tiles 702 are spaced apart with gaps, like gap 706, between each piece of non-accent tile 706. In FIG. 7, the non-accent tile 702 has already been installed and attached to the underlying wall surface 710. The next step in the installation process is for decorative and thinner accent tile 502 to be installed between each piece of non-accent tile 702 in the gap area 706 currently shown in FIG. 7, including between the first piece 724 of non-accent tile 702 and the second piece 726 of non-accent tile 702. Further, in the example shown in FIG. 7, the distance 722 of the gap 706 between the surrounding non-accent tile 702 is supposed to be equivalent to the length 507 of the corresponding piece of accent tile 502 because when the accent tile 502 is positioned in the gap 706, the length 507 of the accent tile 702 will extend across the gap 706. Accordingly, in this instance the size of the gap 706 corresponds to the length 507 of the corresponding piece of accent tile 502. Accordingly, the distance 722 for the gap 706 has been measured and created to be equivalent to the length 507 of the accent tile 502, in this embodiment, so that a contractor can apply mortar, such as mortar 902 shown in FIG. 9, and then position the accent tile 502 over the applied mortar 902. In the instance where the accent tile 502 is oriented differently such that the width 509 of the accent tile 502 is the controlling measurement for the gap 706 and the distance 722 between a first piece 724 of non-accent tile 702 and the second piece 726 of non-accent tile 702, then the gap 706 measurement corresponds to the width 509 of the accent tile 502.

FIG. 8 shows that the assembled mortar correction tool 102 can be positioned against a proximate edge 716 of a first piece 724 of surrounding non-accent tile 702 and a proximate edge 718 of a second piece 726 of surrounding non-accent tile 702. In the example shown in FIG. 7, each piece of non-accent tile 702 on the underlying wall surface 710 is placed above and below each piece of accent tile 502, but the same method and system works for a floor surface 1602 application of accent tile 502, such as that shown in FIGS. 16-17, whereby in that case, the surrounding piece of non-accent tile 702 is placed on either side or to the left and right of the accent tile 502.

In FIG. 8, the vertical edge 612 of the offset 220 of the assembled mortar correction tool 102 is placed against and contacts the first piece 724 of surrounding non-accent tile 702 just above the first proximate edge 716 of the first piece of surrounding non-accent tile 702. A contractor may use one or more hands 804 when using the mortar correction tool 102 to position the mortar correction tool 102 and handle the mortar correction tool 102. Further, the user may position the mortar correction tool 102 so that the bottom edge 806 of the third piece 112 may rest on top of the proximate edge 718 of the second piece of non-accent tile 702.

As shown in FIG. 8, the assembled mortar correction tool 102 has been adjusted so that the third piece 110 is adjusted manually, by moving the components and inserting one or more fastener sets 202-208 therethrough or through other slidable means, in a lateral direction to reflect and mirror the thickness 508 of the corresponding piece of accent tile 502. When the offset 220 is formed, a side edge 190 of the third piece 112 that makes up or creates the leading edge 210 of the mortar correction tool 102 projects forward past the side edge 107 of the top piece 106 of the first piece 104 of the mortar correction, as shown in FIG. 1. Accordingly, the mortar correction tool 102 and its components can be adjusted to reflect a thickness 508 of accent tile 502. As noted above, the second piece 110 may also be shifted laterally to create and/or be a part of a leading edge 210 also in other embodiments along with the third piece 112.

Further, the mortar correction tool 102 can be adjusted to reflect the distance 722 between the first piece 724 and the second piece 726 of non-accent tile 702, whereby that distance 722 is equivalent to the length 507 or width 509 of the accent tile 502, depending on how the accent tile 502 is installed between the pieces 724, 726 of non-accent tile 702. To do so, the contractor measures the length 507 or width 509 of the accent tile 502. Next, the third piece 112 is adjusted vertically as positioned on the top piece 106 so that a bottom edge 806 of the third piece 112 contacts a proximate edge 718 of the second surrounding piece 726 of non-accent tile 702. In this manner, the mortar correction tool 102 can scrape off the desired amount of mortar 902 to remove enough excess mortar 902 to provide room for an accent tile 502 to be applied having a certain thickness 508, and the mortar correction tool 102 can span the distance 722 over the corresponding gap 706 between the surrounding pieces of non-accent tile 702.

As noted above, the user manually manipulates a position of the third piece 112 with respect to the top piece 106 and to the bottom piece 108 and manually manipulates a position of the second piece 110 on the bottom piece 108, by loosening and tightening the fastener sets 202, 204, 206, and 208 as needed to allow for the slidable adjustability in either a horizontal direction, as is the case for the third piece 112 and the second piece 110, or in a vertical direction, as is also the case for the third piece 112.

The series of slots 133a-133j in the third piece 112 allow the user to incrementally (e.g., by increments of 0.25 inches) raise and lower the third piece 112 via the vertical slit 152 with the series of slots 133a-133j of the third piece 112 aligned with the series or plurality of slots 120a-120j of the top piece 106 of the fixed in place first piece 104.

FIGS. 9-15 may show one or more steps that a user may engage in when installing non-accent tile 702 and accent tile 502 while using the mortar correction tool 102 to correct the amount of mortar 902 used to apply the accent tile 502. FIG. 9 shows that a first amount of mortar 902 has been applied by a user to the gap area 706, as shown in FIG. 7, between each piece of surrounding non-accent tile 702. The user may liberally apply the first amount of mortar 902 in a thick layer to the gap 706 area between each piece of surrounding non-accent tile 702, as shown in FIG. 9, because the user knows that the mortar correction tool 102 can remove and scrape off the excess amount (e.g., excess amount 1202 as shown in FIG. 12) needed to install the accent tile 502 with its respective thickness 508 so as to adhere to the underlying wall surface 710 while not projecting past the surrounding non-accent tile 702 pieces.

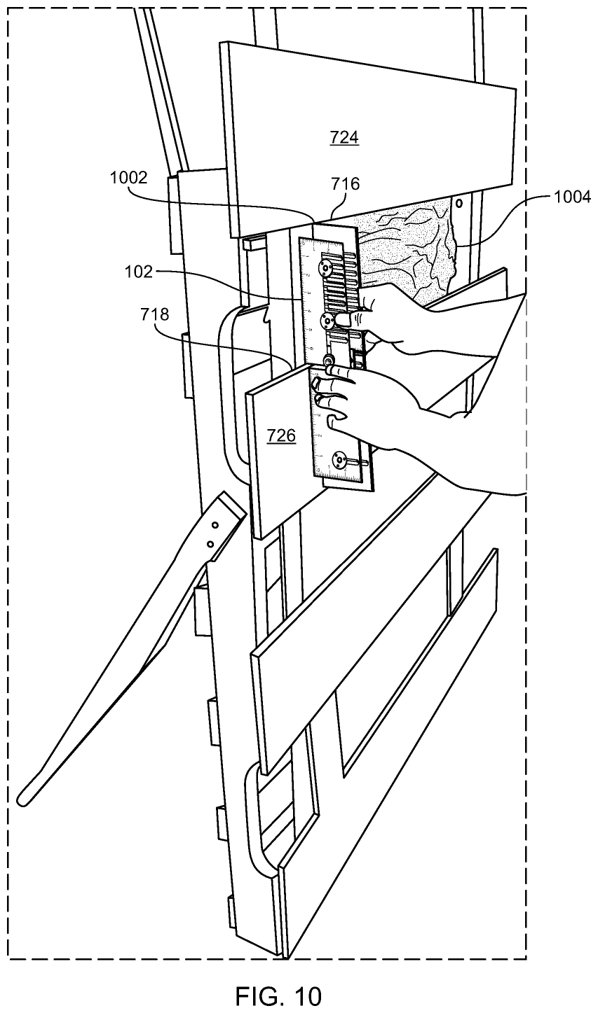

FIG. 10 shows an example of a user first applying the assembled and adjusted mortar correction tool 102 on top of the applied first amount of mortar 902. The user may use one or more hands 804, as shown in FIG. 8, to hold the assembled mortar correction tool 102 vertically upright against the surrounding non-accent tile 702 that has already been installed on the wall surface 710 with gap areas 706 between each piece of surrounding non-accent tile 702 for the accent tile 502 to be positioned. The assembled mortar correction tool 102 has been adjusted to reflect a thickness 508 and to reflect the distance 722 between each piece of non-accent tile 702 that corresponds to relevant length 507 or width 509 accent tile 502 as discussed above.

The user may place the vertical edge 612 of the offset 220 portion of the assembled and adjusted mortar correction tool 102 against an area of the first piece of surrounding non-accent tile 702 that is just above the proximate edge 716 of the first piece of surrounding non-accent tile 702. Further, the user may place the bottom edge 806 of the third piece 112 of the mortar correction tool 102 onto the proximate edge 718 of the second piece of surrounding non-accent tile 702. The bottom edge 806, as shown in FIG. 8, of the third piece 112 may rest on top of the top surface 708, as shown in FIG. 7, of the second piece 726 of non-accent tile 702. When the user passes the mortar correction tool 102 from a first end 1002 of applied mortar 902, as shown in FIG. 10, to a second end 1004 of applied mortar 902, the mortar correction tool 102 contacts and runs along the top surface 708 of the second piece of non-accent tile 702 in order to scrape of any excess amount 1202 of mortar 902, as shown in FIGS. 9-11.

As noted above, the leading edge 210 of the mortar correction tool 102, as comprised of at least side 190 of the third piece 112 and also possibly side 111 of the second piece 110, is directly contacting the first amount of applied mortar 902 and scraping off an amount equal to the offset 220, which is equal to the thickness 508 of the accent tile 502.

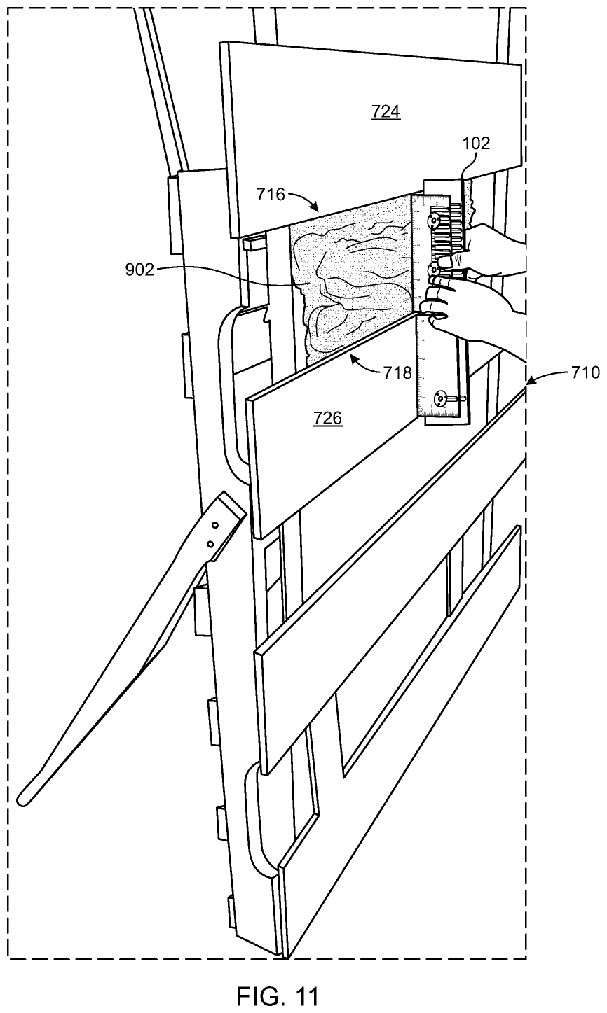

As shown in FIG. 11, the user carefully presses and moves the mortar correction tool 102 in a first pass over the mortar 902. In the example shown in FIGS. 9-15, the user carefully presses and moves the mortar correction tool 102 in a lateral direction over the applied mortar 902 because the surrounding non-accent tile 702 is installed in this manner so that its width is longer than its length. In other examples, the surrounding non-accent tile 702 may be installed so its width is shorter than its length and the user may move the mortar correction tool 102 in a vertical direction downwards or upwards over the applied mortar 902 in that case.

It is noted that the user may pass the mortar correction tool 102 in one, two, three, or as many passes as needed to build up the right surface of mortar beneath the accent tile 502 that will be installed in the gap 706 between a first piece 724 of non-accent tile and a second piece 726 of non-accent tile 702. The mortar will still have the right thickness to allow the accent tile 502 to sit on top of the smoothed surface, layer of mortar 902 while being flat and not projecting past the first piece 724 or second piece 726 of non-accent tile 702. However, the user may need to take more than one pass using the mortar correction tool 102 over the mortar 902 to build a strong, thick, robust layer that does not have holes and is level and flat also. Further, the user can turn the mortar correction tool 102 in a reverse direction and scrape of the mortar 902 in multiple passes because the straight top and bottom edges 194, 196 of the third piece 112 when adjusted by the user will reflect the offset 220 on both the top and bottom end thereby allowing the user to use the adjusted mortar correction tool 102 to scrape off the layers of mortar 902. This is true whether the mortar correction tool 102 is front facing in accordance with the front facing assembly shown in FIG. 2 and in FIG. 6 or rear-facing in accordance with the rear facing assembly shown in FIG. 3.

As shown in FIG. 11, in a non-limiting embodiment, the mortar correction tool 102 continuously contacts the mortar 902 between the proximate edge 716 of the first surrounding piece 724 of non-accent tile 702 and the proximate edge 718 of the second surrounding piece 726 of non-accent tile 702. The user holds the mortar correction tool 102 steady so that the projecting edge 190 of the third piece 112 is contacting and moving over the applied mortar 902 with each pass.

FIG. 11 shows how the initially amount of thick mortar 902 begins to be smoothed down into an even and reduced amount of mortar 902 using the mortar correction tool 102.

FIG. 12 shows buildup of excess mortar 1202 that may build up on the leading edge 210 of the mortar correction tool 102 (i.e., at least the projecting side edge 190 of the third piece 112) of the mortar correction tool 102. The user may continuously clean off this excess amount of mortar 1202 as needed with a sponge or other tool to keep the leading edge 210 of the mortar correction tool 102 and projecting side edge 190 of the third piece 112 clean of excess mortar 1202.

Once the user has passed over the mortar 902 one or more times to remove the excess mortar 902, a smooth, even, and reduced layer of mortar 902 as compared to the initial amount of mortar 902 should remain in the gap area 706 between each surrounding piece of non-accent tile 702 as shown in FIG. 13.

FIG. 14 shows that the accent tile 502 which may be pressed onto and placed over the smoothed layer of mortar 902 from FIG. 13. The accent tile 502 may be positioned and adhered via the mortar 902 to the wall surface 702 as one piece or broken up into multiple pieces and arranged in the desired orientation and layout over the smoothed layer of mortar 902. It is noted that prior to installing the accent tile 502 over the mortar 902, the user may want to allow the smoothed layer of mortar 902 some time to dry and harden but not overharden. Further, the user may want to apply a very thin layer of other types of adhesives, mastics, or additional mortars to allow the accent tile 502 to best adhere to the mortar 902. It is noted that the user may use a variety of tools when applying the mortar 902 including any type of trowels, scrapers, knives, or other tools to apply the mortar 902 and/or other types of bonding material.

Once the accent tile 502 has been completely installed, as shown in FIG. 15, the accent tile 502 will fit nicely and properly between each piece of surrounding non-accent tile 702. The remaining amount of mortar 902 beneath the installed accent tile 502, shown in FIG. 15, does not cause the accent tile 502 to project past the edges of the surrounding non-accent tile 702 and the accent tile 502 has a flat, flush profile in comparison with the first piece 724 of non-accent tile 702 and the second piece 726 of non-accent tile 702. Further, the accent tile 502 is level and even along its length 507 and width 509, because the remaining amount of smoothed out mortar 902 does not include lumpy, uneven areas beneath the accent tile 502 or have an abundance of extra mortar 902 in some areas beneath the accent tile 502 over other areas.

Accordingly, the mortar correction tool 102 is very useful to scrape off and remove a desired amount of mortar 902 in one or more passes. Conventionally, without a mortar correction tool 102, the user has to guess and estimate how much mortar 902 from an initial amount to scrape off and remove, which involves many attempts to ensure that the accent tile 502 is applied in an even layer and does not project over the surrounding pieces of non-accent tile 702. This wastes valuable time and adds cost to the overall installation of tile project in labor and materials because an excessive amount of mortar 902 may be wasted in this manner and the contractors may charge more for the installation of accent tile. Further, it is frequently the case using conventional means, without the benefit of a mortar correction tool 102, that the applied accent tile 502 between surrounding pieces of non-accent tile 702 is uneven in many spots on a wall 710 or floor surface and not level with the surrounding non-accent tile 702.

FIGS. 16-17 show how the mortar correction tool 102 may be used in the same manner as described above, but for a floor surface application 1602 of accent tile 502 (not shown in FIGS. 16-17) between two pieces of surrounding non-accent tile 702 (i.e., a first piece 1624 of non-accent tile 702 and a second piece 1626 of non-accent tile 702). The user may in the same manner as noted above with respect to FIGS. 7-15, adjust the mortar correction tool 102 to reflect the thickness 508 and length 507 or width 509 of the corresponding piece of accent tile 502 and smooth out the initial amount of mortar 902 applied to a gap 706 between each piece of surrounding non-accent tile 702 by passing the mortar correction tool 102 over the mortar 902 in the same manner as noted above with respect to FIGS. 7-15 even for an application on a floor surface 1602. Accordingly, the mortar correction tool 102 can be oriented as a whole in a vertical direction or a horizontal direction whether used on a wall surface 710 or a floor surface 1602.

After use of the mortar correction tool 102, the user may want to clean off the mortar correction tool 102 so as to remove any mortar 902 stuck to the mortar correction tool 102 and to keep the mortar correction tool 102 for use on a later project having accent tile 502 installation. In a non-limiting embodiment, the user may use wipes or soap and water to clean off the components of the mortar correction tool 102.

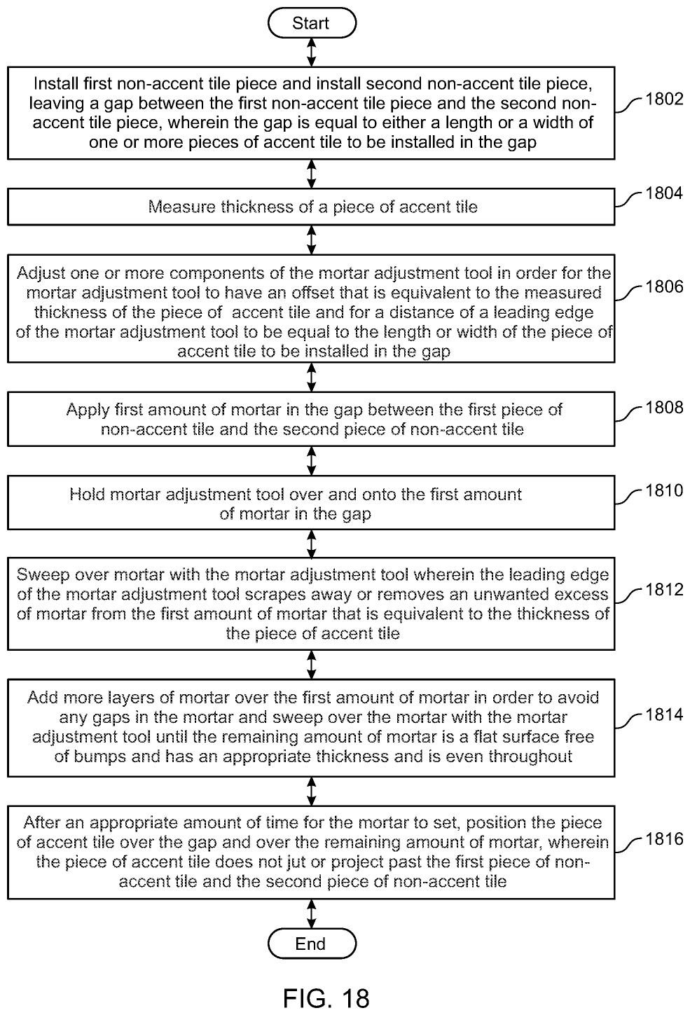

FIG. 18 provides an exemplary flowchart for using a mortar correction tool 102. At step 1802, the method may include installing a first piece 724, 1624 of non-accent tile 702 and installing a second piece 726, 1626 of non-accent tile 702 on a wall surface 710, as shown in FIG. 7, or a floor surface 1602, as shown in FIG. 16. A gap 706 should be created between the first piece 724, 1624 of non-accent tile 702 and the second piece 726, 1626 of non-accent tile 702 that is equal to a length 507 or width 509 of the accent tile 502 to be installed in the accent tile gap 706. It is assumed that the user has measured the length 507 and/or width 509 of the accent tile 502 to be installed in the accent tile gap 706. As noted above, the user can use one or more rulers 138 includes on the components of the mortar correction tool 102 or use a separate measuring device.

At step 1804, the user may measure a thickness 508 of the accent tile 502. At step 1806, the user may adjust one or more components (e.g., second piece 110 and third piece 112 with respect to the top piece 106 and the bottom piece 108 of the first piece 104) of the mortar correction tool 102 in order for the mortar correction tool 102 to have an offset 220 that is equivalent to the measured thickness 508 of the accent tile 502. Further, the components of the mortar correction tool 102 may need to be adjusted to reflect the proper distance 722 of the gap 706 between the first piece 724, 1624 and second piece 726, 1626 of the non-accent tile 702, whereby that distance 722 corresponds to a length 507 or width 509 of the accent tile 502.

At step 1808, the method may include applying a first amount of mortar 902 in the gap 706 between the first piece 724, 1624 and the second piece 726, 1626 of non-accent tile 702. At step 1810, the method may further include the user holding or positioning the assembled mortar correction tool 102 over and onto the first amount of mortar 902 in the gap 706.

At step 1812, the method may include sweeping over the mortar 902 with the assembled mortar adjustment tool 102 whereby the leading edge 210 of the mortar adjustment tool 102 scrapes away the first amount of mortar 902 to remove an unwanted excess of mortar 902 from the first amount of mortar 902 that is equivalent to the thickness 508 of the accent tile 502. It is recommended that the user clean off any built up excess 1202 of mortar 902, as shown in FIG. 12, by using a sponge or other tool to clean off the leading edge 210 of the mortar correction tool 102 in between passes and further applications of additional corrective layers of mortar 902. This may be so that the excess 1202 does not interfere with the proper desired thickness of the mortar 902 or creates uneven sections of mortar 902 in the gap 706.

At step 1814, the method may further include adding more layers of mortar 902 over the first amount of applied mortar 902 in order to avoid any gaps or holes in the mortar 902 and sweeping over the mortar 902 a couple passes with the mortar adjustment tool 102 until the remaining amount of mortar 902 is a generally flat surface, free of too many bumps and uneven sections and as an appropriate thickness (while leaving enough space for the thickness of the accent tile 502 to be applied) and is even throughout.

At step 1816, after an appropriate amount of time for the mortar 902 to set, the method may include positioning the piece of accent tile 502 over the gap 706 and over the remaining amount of mortar 902, whereby the end result should be that the accent tile 502 does not just out or project past the first piece 724, 1624 of non-accent tile 702 and the second piece 726, 1626 of non-accent tile 702.

Advantageously , when using the mortar correction tool 102, there is less time spent in installing accent tile 502 and the user can ensure that the accent tile 502, whether applied on a wall surface 710 as a backsplash or in the shower of a bathroom or to a floor surface 1602 for an added decorative feature and to draw the eye, is applied evenly and uniformly without having excess mortar 902 or too little mortar 902 beneath the applied accent tile 502, which can cause problems later in the proper adherence of the accent tile 502 to the underlying wall surface 710 or floor surface 1602 over time. Many other advantages and benefits may be provided by the mortar correction tool 102 as described herein.

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, and steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted. The term “coupled to” as used herein may refer to a direct or indirect connection.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A mortar correction tool comprising:
a first piece, the first piece comprising:
a top piece comprising a plurality of slots;
a bottom piece comprising a first slot positioned near a top surface of the top piece and a second slot positioned near a bottom surface of the top piece,
wherein the top piece and the bottom piece are fixedly attached to each other,
wherein a lower surface of a back side of the top piece is fixedly attached on top of an upper area on a front side of the bottom piece such that an overhang forms over the bottom piece;
a second piece comprising a first slot that extends partially along a width of the second piece near a top surface of the second piece and a second slot that extends partially along the width of the second piece near a bottom surface of the second piece; and
a third piece, the third piece comprising an angled slope at a bottom surface of the third piece, wherein the third piece further comprises a backwardly oriented L-shaped slit carved out of a middle of the third piece, the backwardly oriented L-shaped slit having a vertical slit that is perpendicular to a horizontal slit carved in the middle of the third piece,
wherein a series of slots extend in a horizontal direction adjacent to the vertical slit and extend into the vertical slit,
wherein the series of slots of the third piece are configured to align horizontally with the plurality of slots of the top piece of the first piece,
wherein when assembled, the second piece is configured to be positioned over the bottom piece of the first piece under the overhang formed by the top piece,
wherein the second piece is configured to be held in place with a first fastener that passes through the second slot of the bottom piece and through the second slot of the second piece,
wherein the third piece is attachable over the top piece of the first piece with one or more fasteners,
wherein the one or more fasteners are insertable into the plurality of slots of the top piece of the first piece and are also insertable into the series of slots of the third piece,
wherein a position of the second piece is adjustable in a horizontal direction,
wherein a position of the third piece on the mortar correction tool is adjustable in the horizontal direction by adjusting a position of the series of slots of the third piece in the horizontal direction over the plurality of slots of the top piece of the first piece,
wherein the position of the third piece is also adjustable in a vertical direction by adjusting an alignment of the vertical slit of the third piece with the plurality of slots of the top piece of the first piece,
wherein the position of the third piece on the mortar correction tool is adjustable in the horizontal direction in order to provide a leading edge on the mortar correction tool that is offset from the first piece at a distance substantially equivalent to a thickness of a corresponding piece of accent tile.

2. The mortar correction tool assembly of claim 1, wherein a second fastener is configured to couple the third piece over the top piece of the first piece and is configured to extend through a first slot of the plurality of slots of the top piece of the first piece through a first slot of the series of slots of the third piece.

3. The mortar correction tool of claim 2, wherein a third fastener is configured to couple the third piece over the top piece through a second slot of the plurality of slots of the top piece of the first piece through a second slot of the series of slots of the third piece.

4. The mortar correction tool of claim 3, wherein a fourth fastener is configured to extend through the first slot positioned near a top surface of the top piece of the first piece, and through the first slot that extends partially along the width of the second piece near the top surface of the second piece, and through a lower opening or portion of the vertical slit carved in the middle of the third piece.

5. The mortar correction tool of claim 1, wherein a first ruler extends along a top horizontal side of the third piece and a second extends along a vertical side of the third piece, wherein the vertical side of the third piece is part of or forms a leading edge of the mortar correction tool.

6. The mortar correction tool of claim 5, wherein a third ruler extends along a bottom horizontal side of the second piece and a fourth ruler extends along a vertical side of the second piece, wherein the fourth ruler is positioned on a same side as the second ruler of the third piece.

7. The mortar correction tool of claim 1, wherein the first piece, the second piece, and the third piece are each rectangular shaped.

8. The mortar correction tool of claim 1, wherein the plurality of slots of the top piece of the first piece are wider than the series of slots of the third piece.

9. The mortar correction tool of claim 1, wherein a thickness of the second piece is equivalent to or less than a distance of the overhang of the top piece over the bottom piece of the first piece.

10. The mortar correction tool of claim 1, wherein the top piece and the bottom piece of the first piece are removably attached to each other.

11. A method of using a mortar correction tool when applying accent tile, the method comprising:
providing the mortar correction tool, the mortar correction tool comprising:
a first piece, the first piece comprising:
a top piece comprising a plurality of slots;
a bottom piece comprising a first slot positioned near a top surface of the top piece and a second slot positioned near a bottom surface of the top piece,
wherein the top piece and the bottom piece are fixedly attached to each other,
wherein a lower surface of a back side of the top piece is fixedly attached on top of an upper area on a front side of the bottom piece such that a bottom edge of the top piece forms an overhang over the bottom piece;
a second piece comprising a first slot that extends partially along a width of the second piece near a top surface of the second piece and a second slot that extends partially along the width of the second piece near a bottom surface of the second piece; and
a third piece, the third piece comprising an angled slope at a bottom surface of the third piece, wherein the third piece further comprises a backwardly oriented L-shaped slit carved out of a middle of the third piece, the backwardly oriented L-shaped slit having a vertical slit that is perpendicular to a horizontal slit carved in the middle of the third piece, wherein a series of slots extend adjacent to the vertical slit and extend into the vertical slit, wherein the series of slots of the third piece are configured to align horizontally with the plurality of slots of the top piece of the first piece,
wherein when assembled, the second piece is configured to be positioned over the bottom piece of the first piece under the overhang formed by the top piece,
wherein the second piece is configured to be held in place with a first fastener that passes through the second slot of the bottom piece and through the second slot of the interior piece,
wherein the third piece is attachable over the top piece of the first piece with one or more fasteners,
wherein the one or more fasteners are insertable into the plurality of slots of the top piece of the first piece and are also insertable into the series of slots of the third piece,
wherein a position of the second piece is adjustable in a horizontal direction,
wherein a position of the third piece on the mortar correction tool is adjustable in the horizontal direction by adjusting a position of the series of slots of the third piece in the horizontal direction over the plurality of slots of the top piece of the first piece,
wherein the position of the third piece is also adjustable in a vertical direction by adjusting an alignment of the vertical slit of the third piece with the plurality of slots of the top piece of the first piece,
wherein the position of the third piece on the mortar correction tool is adjustable in the horizontal direction on the mortar correction tool is adjustable in the horizontal direction in order to provide a leading edge on the mortar correction tool that is offset from the first piece at a distance substantially equivalent to a thickness of a corresponding piece of accent tile;
installing a first piece of non-accent tile on a floor surface or a wall surface;
installing a second piece of non-accent tile on the floor surface or the wall surface, wherein there is an accent tile gap between the first piece and the second piece of the non-accent tile, wherein the accent tile gap is configured to receive the accent tile;
applying a first amount of mortar over the accent tile gap between the first piece and the second piece of the non-accent tile;
measuring a thickness of the accent tile;
measuring a distance between a first proximate edge of the first piece of non-accent tile and a first proximate edge of the second piece of non-accent tile;
using the mortar correction tool to remove an excess amount of mortar, further comprising;
adjusting the mortar correction tool to be sized to reflect the thickness of the accent tile, further comprising:
adjusting horizontally a third piece of the mortar correction tool that is offset a distance from a lateral side of a first piece of the mortar correction tool, wherein the distance is substantially equivalent to the thickness of the accent tile;
adjusting the mortar correction tool to be sized to reflect the distance between the first proximate edge of the first piece of non-accent tile and the first proximate edge of the second piece of non-accent tile, further comprising:
adjusting vertically the third piece of the mortar correction and if additional length is needed to fit the distance between the first proximate edge of the first piece of non-accent tile and the first proximate edge of the second piece of non-accent tile, further adjusting horizontally the second piece to extend past a lateral side of the second piece of the mortar correction tool;
positioning the leading edge of the mortar correction tool against the applied first amount of mortar, the leading edge of the mortar correction tool comprising at least a first leading lateral side of the top piece of the first piece,
passing the adjusted mortar correction tool along and over the first amount of mortar and smoothing out the first amount of mortar;
upon passing the adjusted mortar correction tool along and over the first amount of mortar, scraping or removing an excess amount of mortar from the first amount of mortar,
wherein the removed excess amount of mortar is substantially equivalent to the thickness of the accent tile;
applying additional layers of mortar if needed;
after completing the passing of the adjusted mortar correction tool over the additional layers of mortar a desired number of times, having a smoothed layer of mortar with a reduced amount of mortar from the first amount of mortar, wherein the smoothed layer of mortar has been reduced to accommodate a placing of the accent tile over the smoothed layer of mortar and has a correct amount of mortar at a desired thickness to accommodate the thickness of the accent tile; and
positioning the accent tile over the smoothed layer of mortar, wherein the accent tile is evenly positioned between the first piece and the second piece of non-accent tile and does not project over or above the first piece and the second piece of non-accent tile.

12. The method of claim 11, wherein passing the adjusted mortar correction tool along and over the first amount of mortar and smoothing out the first amount of mortar further comprises:
contacting the first proximate edge of the first piece of non-accent tile with a top edge of the top piece of the first piece of the mortar correction tool and contacting the first proximate edge of the second piece of non-accent tile with a bottom edge of the top piece and/or a bottom edge of the second piece while passing the adjusted mortar correction tool along and over the first amount of mortar.

13. The method of claim 11, wherein the excess amount of mortar builds up and collects on the leading edge of the mortar correction tool.

14. The method of claim 13, further comprising, cleaning off the removed excess amount of mortar that built up or collected on the leading edge of the mortar correction tool prior to passing of the adjusted mortar correction tool over the additional layers of mortar for the desired number of times.

15. The method of claim 11, wherein a width of the second piece is equal to a width of the bottom piece of the first piece.

16. The method of claim 11, wherein the distance between the first proximate edge of the first piece of non-accent tile and the first proximate edge of the second piece of non-accent tile is generally equivalent to a length of the accent tile.

17. The method of claim 16, wherein the accent tile is positioned over the smoothed layer of mortar such that the length of the accent tile spans the distance between the first proximate edge of the first piece of non-accent tile and the first proximate edge of the second piece of non-accent tile.

18. The method of claim 11, wherein the distance between the first proximate edge of the first piece of non-accent tile and the first proximate edge of the second piece of non-accent tile is generally equivalent to a width of the accent tile.

19. The method of claim 18, wherein the accent tile is positioned over the smoothed layer of mortar such that the width of the accent tile spans the distance between the first proximate edge of the first piece of non-accent tile and the first proximate edge of the second piece of non-accent tile.

20. The method of claim 11, wherein the top piece and the bottom piece of the first piece are removably attached to each other.
